(19) United States
(12) Patent Application Publication
(10) Pub. No.: US 2026/0280638 A1
(43) Pub. Date: Sep. 17, 2026

(54) DEVICES AND METHODS FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 19/167,935

(22) PCT Filed: Mar. 24, 2023
(86) PCT No.: PCT/CN2023/083764

§ 371 Date: Sep. 23, 2025

(51) Int. Cl. H04B 7/06; H04L 1/1607; H04L 5/00

(52) U.S. Cl. CPC H04B 7/0626; H04L 1/1614; H04L 5/0048

(57) ABSTRACT

Embodiments of the present disclosure provide a solution for transmission configuration indicator (TCI) selection. In the solution, a terminal device determines, a bitmap of channel state information reference signal (CSI-RS) resource and a first parameter combination from at least one parameter combination for codebook, the first parameter combination corresponding to a first number of CSI-RS resources and a first parameter set for codebook, the bitmap of CSI-RS resource indicating a second number of CSI-RS resources selected by the terminal device; determine a second parameter set for codebook based at least in part on a first parameter aggregation determined based on: the first parameter combination, and the bitmap of CSI-RS resource; and transmit, based at least in part on the second parameter set, a report indicating at least one codebook indicator to the network device. In this way, the overhead for reporting the at least one codebook indicator is reduced.

### FIELDS

Example embodiments of the present disclosure generally relate to the field of communication techniques and in particular, to devices and methods for codebook configuration.

### BACKGROUND

Technology of multiple input multiple output (MIMO) has been widely used in current wireless communication system, where a large number of antenna elements are used by a network device for communicating with a terminal device for both sub-6 GHz and over-6 GHz frequency bands. Further, in order to improve the reliability and robustness of the communication between the network device and the terminal device, technology of multi-transmission and reception point (multi-TRP/M-TRP) has been proposed and discussed.

In order to improve the transmission performance, the network device may transmit codebook-related configuration(s) to the terminal device, and the terminal device may provide codebook indicator(s) to the network device. As the increasing numbers of TPRs, channel state information reference signal (CSI-RS) resources, {Ln} combination (wherein {Ln} associates with numbers of spatial domain (SD) basis) and so on, the overhead for providing the codebook indicator(s) is increased significantly, which is unexpected. Thus, it would be desirable to propose a solution where the codebook indicator(s) may be provided by the terminal device with a lower overhead.

### SUMMARY

In general, embodiments of the present disclosure provide a solution for codebook configuration.

In a first aspect, there is provided a terminal device comprising: a processor configured to cause the terminal device to: determine, a bitmap of channel state information reference signal (CSI-RS) resource and a first parameter combination from at least one parameter combination for codebook, the first parameter combination corresponding to a first number of CSI-RS resources and a first parameter set for codebook, the bitmap of CSI-RS resource indicating a second number of CSI-RS resources selected by the terminal device; determine a second parameter set for codebook based at least in part on a first parameter aggregation determined based on: the first parameter combination and the bitmap of CSI-RS resource; and transmit, based at least in part on the second parameter set, a report indicating at least one codebook indicator to the network device.

In a second aspect, there is provided a network device comprising: a processor configured to cause the terminal device to: transmit, to a terminal device, at least one codebook configuration indicating a plurality of parameters to be used by the terminal device, the plurality of parameters comprising: a first parameter indicating a maximum number of CSI-RS resources, a second parameter indicating a number of at least one parameter combination for codebook, a third parameter indicating the at least one parameter combination for codebook, a fourth parameter indicating a plurality of supported parameter sets for codebook, and a fifth parameter indicating whether selection of at least one CSI-RS resource is enabled, receive, from the terminal device, a report indicating at least one codebook indicator generated based on the codebook configuration.

In a third aspect, there is provided a communication method performed by a terminal device. The method comprises: determining, a bitmap of channel state information—reference signal (CSI-RS) resource and a first parameter combination from at least one parameter combination for codebook, the first parameter combination corresponding to a first number of CSI-RS resources and a first parameter set for codebook, the bitmap of CSI-RS resource indicating a second number of CSI-RS resources selected by the terminal device; determining a second parameter set for codebook based at least in part on a first parameter aggregation determined based on: the first parameter combination and the bitmap of CSI-RS resource; and transmitting, based at least in part on the second parameter set, a report indicating at least one codebook indicator to the network device.

In a second aspect, there is provided a communication method performed by a network device. The method comprises: transmitting, to a terminal device, at least one codebook configuration indicating a plurality of parameters to be used by the terminal device, the plurality of parameters comprising: a first parameter indicating a maximum number of CSI-RS resources, a second parameter indicating a number of at least one parameter combination for codebook, a third parameter indicating the at least one parameter combination for codebook, a fourth parameter indicating a plurality of supported parameter sets for codebook, and a fifth parameter indicating whether selection of at least one CSI-RS resource is enabled, receiving, from the terminal device, a report indicating at least one codebook indicator generated based on the codebook configuration.

In a fifth aspect, there is provided a computer readable medium having instructions stored thereon, the instructions, when executed on at least one processor, causing the at least one processor to carry out the method according to the third or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIGS. TA to 1C illustrates example communication environments in which example embodiments of the present disclosure can be implemented;

FIG. 2 illustrates a signaling flow of communication in accordance with some embodiments of the present disclosure;

FIG. 3 illustrates example linkages between parameter combinations and parameter sets;

FIG. 4 illustrates an example correspondence among the codebook-related parameters;

FIG. 5 illustrates another example correspondence among the codebook-related parameters;

FIG. 6 illustrates a flowchart of a method implemented at a terminal device according to some example embodiments of the present disclosure;

FIG. 7 illustrates a flowchart of a method implemented at a network device according to some example embodiments of the present disclosure;

FIG. 8 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, technology of MIMO has been widely used in current wireless communication system. In release 18 of 3GPP, more discussions about channel state information (CSI) enhancement especially for coherent joint transmission (CJT) will be made. Specifically, by assuming ideal backhaul and synchronization as well as the same number of antenna ports across TRPs, specify enhancements of CSI acquisition for CJT targeting frequency range 1 (FR1) and up to 4 TRPs, as follows:
Type-II codebook refinement for CJT M-TRP targeting FDD and its associated CSI reporting, taking into account throughput-overhead trade-off;
SRS enhancement to manage inter-TRP cross-sounding reference signal (SRS) interference targeting time division duplexing (TDD) CJT via SRS capacity enhancement and/or interference randomization, with the constraints the following:
1) without consuming additional resources for SRS;
2) reuse existing SRS comb structure;
3) without new SRS root sequences.

Further, it is expected that in release 18 of 3GPP, the maximum number of CSI-RS ports per resource remains the same as in the previous releases (such as, 32 CSI-RS ports in release 17).

Further, in current wireless communication system, the network device may transmit a codebook configuration to the terminal device, and the terminal device may provide codebook indicator(s) to the network device. Taking the Type-II codebook as one example scenario, in the legacy solution, after receiving the codebook configuration, the terminal device may determine parameter L (where L is a number of SD basis). Further, in order to better support CJT NTRP, dynamic selection of {Ln} combination is agreed to be supported (wherein {Ln} associates with numbers of spatial domain (SD) basis).

Specifically, the terminal device may determine a first {Ln} combination from a plurality of {Ln} combinations configured by the network device, where the first {Ln} combination corresponds to a first number of CSI-RS resources. When determining the at least one codebook indicator to be reported, the terminal device may further select a second number of CSI-RS resources decided to be report, where the second number may be smaller than the first number.

According to a normal operation, the terminal device would determine a first parameter set {pᵥ, β} corresponding to the first {Ln} combination, and report at least one codebook indicator based at least in part on the first parameter set {pᵥ, β}. However, as the second number of CSI-RS resources decided by the terminal device is smaller than the first number of CSI-RS resources configured by the network device, part of the overhead for reporting the at least one codebook indicator according to the normal operation is unnecessary. That is, the normal operation results resource waste.

According to the present disclosure, the terminal device determines a bitmap of CSI-RS resource and a first parameter combination, where the first parameter combination corresponds to a first number of CSI-RS resources and a first parameter set for codebook, and the bitmap of CSI-RS resource indicates a second number of CSI-RS resources selected by the terminal device. Next, the terminal device determines a second parameter set for codebook based at least in part on a first parameter aggregation, where the first parameter aggregation is determined based on the first parameter combination and the bitmap of CSI-RS resource. After that, the terminal device transmits, based at least in part on the second parameter set, a report indicating at least one codebook indicator to the network device.

According to the present discourse, by determining a first parameter aggregation based on the first parameter combination and the bitmap of CSI-RS resource, the reported at least one codebook indicator may be determined based on a new parameter set (i.e., the second parameter set corresponding to the first parameter aggregation) rather than the first parameter set. As a result, the overhead for reporting the at least one codebook indicator may be reduced.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “TRP” may refer to an antenna port or an antenna array (with one or more antenna elements) available to the network device located at a specific geographical location. For example, a network device may be coupled with multiple TRPs in different geographical locations to achieve better coverage. Alternatively, or in addition, multiple TRPs may be incorporated into a network device, or in other words, the network device may comprise the multiple TRPs. The term “TRP” may be also referred to as a cell, such as a macro-cell, a small cell, a pico-cell, a femto-cell, a remote radio head, a relay node, etc. It is to be understood that the term “TRP” may refer to a logical concept which may be physically implemented by various manner.

There may be no explicit TRP identification (ID). If multi-downlink control information (M-DCI) is assumed, the TRP ID may be implicitly identified via control resource set (CORESET) Pool Index (CORESETPoolIndex). If single-DCI (S-DCI) is assumed, the TRP ID may implicitly identified via sounding reference signal (SRS) resource set ID for uplink (UL) transmission at least. Therefore, the term “TRP” can be used interchangeably with the terms “CORESETPoolIndex” and SRS resource set.

In the case of M-DCI, a terminal device is configured by a higher layer parameter PDCCH-Config that contains two different values of CORESETPoolIndex in ControlResourceSet for the active bandwidth part (BWP) of a serving cell.

In the case of S-DCI, there is only one value of CORESETPoolIndex in ControlResourceSet.

As used herein, the terms “UE expects”, “UE does not expect, “terminal device expects”, “terminal device does not expect” may imply restrictions on a configuration of a network device (also referred to as NW configuration). The terms “UE is not expected to” and “terminal device is not expected to” may imply a terminal implementation, also referred to as UE implementation. In some embodiments, the terms “UE does not expect” and “UE is not expected to” may be used equally.

As used herein, the terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “transmission configuration indication state (TCI state)”, “UL TCI state”, “joint TCI state”, “transmission configuration indicator”, “quasi co-location (QCL)”, “quasi-co-location”, “QCL parameter”, “QCL assumption”, “QCL relationship” and “spatial relation” can be used interchangeably.

As used herein, the terms “TRP”, “TCI state”, “TCI”, “CORESET”, “CORESET pool”, “UL TCI state”, “DL TCI state”, “joint TCI state”, “separate TCI state” may be used interchangeably.

As used herein, the terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “M-TRP” and “M-TCI”, “M-TRP” can be used interchangeably.

As used herein, the terms “first codebook type”, “codebook enhancement based on release 16 codebook” and “CSI enhancement based on release 16 codebook” can be used interchangeably. In the context of the present application, the terms “second codebook type”, “codebook enhancement based on release 17 codebook” and “CSI enhancement based on release 17 codebook” can be used interchangeably.

For ease of discussion, some terms used in the following description are listed as below:
a first parameter combination: refers to a parameter combination configured/indicated by the network device. The first parameter combination corresponds to a first number of CSI-RS resources and a first parameter set for codebook. In case of a first codebook type and a second codebook type, the first parameter combination may be {Ln} combination, and in case of the second codebook type, the first parameter combination may be {αₙ} combination.
a first parameter aggregation: refers to a parameter combination determined by the terminal device. The first parameter aggregation corresponds to a second number of CSI-RS resources and a second parameter set for codebook. The second number is smaller than (or smaller than or equal to) the first number, and the second parameter set for codebook may result a lower overhead for transmitting the at least one codebook indicator, compared with the first parameter set for codebook. The first parameter aggregation also referred to as a second parameter combination sometimes.

In some embodiments, there may be a first codebook type and a second codebook type. In some embodiments, for the first codebook type, the enhancements may be based on release 16 codebook or based on enhanced Type II codebook. In some embodiments, for the second codebook type, the enhancements may be based on release 17 port selection codebook or based on further enhanced Type II port selection codebook. In some embodiments, the terminal device 110 may be configured with at least one of the first codebook type and the second codebook type, for example, through RRC signalling.

In some embodiments, the terminal device 110 may receive, from the network device 120, at least one configuration for one CSI report, wherein the at least one configuration may include at least one of: a first plurality of CSI-RS resources for channel measurement for the CSI report, at least one parameter combination for codebook for the CSI report. For example, the at least one parameter combination for codebook may be represented as {Lₙ} with 1≤n≤N or 1≤n≤N_{TRP}. (For example, for the first codebook type).

For another example, the at least one parameter combination for codebook may be represented as {αₙ} with 1≤n≤N or 1≤n≤N_{TRP}, for example, for the second codebook type, n may be a positive integer.

A value for first vector for the CSI report (for example, the value for first vector) may be represented as L (for example, for the first codebook type). For another example, the value for first vector may be represented as {αₙ}(for example, for the second codebook type)), at least one value for second vector (e.g. represented as Mᵥ or represented as M) for the CSI report, at least one value for a first parameter (e.g. represented as β) for the CSI report, at least one parameter for antenna port configuration (e.g. a first parameter for antenna port configuration N₁ and a second parameter for antenna port configuration N₂), a codebook type (For example, the first codebook type and/or the second codebook type), at least one parameter for codebook, a total number of precoding matrices in the CSI report (e.g. represented as N₃), at least one value for a sixth parameter for codebook (e.g. represented as pᵥ), a seventh parameter for codebook (e.g. represented as R), and an eighth parameter for codebook (e.g. represented as N_{f}).

In some embodiments, the eighth parameter for codebook N_{f} may be configured when the terminal device 110 is configured with second codebook type. In some embodiments, the eighth parameter for codebook N_{f} may be a size of window for second vectors. In some embodiments, the value of N_{f} may be at least one of {1,2,4} or {2, 4}.

In some embodiments, the at least one parameter combination for codebook may be at least one combination of values for first vector.

In some embodiments, the first plurality of CSI-RS resources may comprise N_{TRP} CSI-RS resources. In some embodiments, N_{TRP} may be a positive integer, and 1≤N_{TRP}≤8 or 1≤N_{TRP}≤4 or 2≤N_{TRP}≤4. In some embodiments, N_{TRP} may be at least one of {1, 2, 3, 4} or at least one of {2, 3, 4}.

In some embodiments, the terminal device 110 may indicate or select or determine or report a second plurality of CSI-RS resources based on the first plurality of CSI-RS resources. In some embodiments, the second plurality of CSI-RS resources may be same as the first plurality of CSI-RS resources. In some embodiments, the second plurality of CSI-RS resources may be a subset of the first plurality of CSI-RS resources. In some embodiments, the number of CSI-RS resources in the second plurality of CSI-RS resources may be N. In some embodiments, N may be a positive integer, and 1≤N≤N_{TRP}. In some embodiments, N may be at least one of {1, 2, 3, 4} or at least one of {2, 3, 4}. In some embodiments, N may be less than or equal to N_{TRP}.

In some embodiments, the second plurality of CSI-RS resources may be indicated or reported based on the bitmap of CSI-RS resource in the CSI report. In some embodiments, the number of bits in the bitmap of CSI-RS resource may be N_{TRP}. In some embodiments, a bit in the bitmap of CSI-RS resource may be represented as bₙ, and the value of bₙ may be either 0 or 1. In some embodiments, the bit bₙ in the bitmap of CSI-RS resource may indicate whether the corresponding CSI-RS resource with index n in the first plurality of CSI-RS resources selected or not.

In some embodiments, the bit bₙ in the bitmap of CSI-RS resource may indicate whether the corresponding CSI-RS resource with index n in the first plurality of CSI-RS resources included or selected in the second plurality of CSI-RS resources or not. In some embodiments, the bitmap of CSI-RS resource may be represented as {bₙ}, wherein 1≤n≤N_{TRP}. In some embodiments, a CSI-RS resource with index n in the first plurality of CSI-RS resources corresponding to a bit value bₙ is selected or is included in the second plurality of CSI-RS resources if the value bₙ=1. In some embodiments, at least one bit in the bitmap of CSI-RS resource may be with value 1.

In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a. In some embodiments, b!=1*2* . . . *(b−1)*b. In some embodiments, (a−b)!=1*2* . . . *(a−b−1)*(a−b). In some embodiments, C(a, b) and/or

$$( \begin{matrix}a \\ b\end{matrix} )$$

may be nchoosek(a, b). In some embodiments, a and/or b may be positive integer. In some embodiments, a may be larger than or no less than b. In some embodiments, 1≤a≤32. In some embodiments, 1≤b≤32. In some embodiments, 1≤b≤a.

In some embodiments, the terminal device 110 may receive the at least one configuration via at least one of RRC, MAC CE and DCI.

In the following, a {Ln} combination will be used as an example of parameter combination for describing some specific example embodiments of the present disclosure. It is noted that example embodiments described with regard to the satellite are equally applicable to other parameter combinations, including but not limited to, {a,} combination.

In the following, a {pᵥ, β} set will be used as an example of parameter set for describing some specific example embodiments of the present disclosure. It is noted that example embodiments described with regard to the {pᵥ, β} set are equally applicable to other parameter set associated with at least one codebook indicator, including but not limited to, {M, β}, {β}, for example, for the second codebook type.

Parameters used in the present disclosure are listed as below:
a {Ln} combination: associates with numbers of spatial domain (SD) basis. A value of a parameter in the {Ln} combination may be one of {1, 2, 4, 6}. Further, the value of the {Ln} combination may be associated with the number of the TRPs (i.e., N_{TRP}). The maximum number of parameters in the {Ln} combination and/or the maximum sum of values of parameters comprised in the {Ln} combination may be implemented as UE capability. Examples of {Ln} combination are illustrated in below table 1.

TABLE 1
Examples of {Ln} combination

| Number of | |
|---|---|
| TRPs (N_{TRP}) | {Lₙ} combination |
| 1 | {2} |
| | {4} |
| | {6} (only for total # ports = 32, rank 1-2, R = 1 |
| 2 | {2, 2} |
| | {2, 4}, {4, 2} |
| | {4, 4} |
| 3 | {2, 2, 2} |
| | {2, 2, 4}, {2, 4, 2}, {4, 2, 2} |
| | {4, 4, 4} |
| 4 | {2, 2, 2, 2} |
| | {2, 2, 2, 4} |
| | {2, 2, 4, 4} |
| | {4, 4, 4, 4} |

a {pᵥ, β} set: associates with a parameter combination, where pᵥ is associated with frequency basis (For example, number of second vectors in the CSI report) and β is associated with non-zero coefficient (For example, number of non-zero coefficients in the CSI report). Examples of supported {pᵥ, β} set are illustrated in below table 2.

TABLE 2
Examples of supported {pᵥ, β} set

| pᵥ for layers 1-4 | β | Condition(s) |
|---|---|---|
| {⅛, ⅛, 1/16, 1/16} | ¼ | — |
| | ½ | — |
| {¼, ¼, ⅛, ⅛} | ¼ | — |
| | ½ | — |
| {¼, ¼, ¼, ¼} | ¾ | — |
| {½, ½, ½, ½} | ½ | Only applicable when N_{TRP} ≤ 3 and |
| | | NL = 1; |
| | | Optional |

N_{TRP}: refers to the maximum number of cooperating CSI-RS resources configured by the network device via higher-layer signaling;
N: refers to the number of cooperating CSI-RS resources, where N∈{1, . . . , N_{TRP}}. The value of N is inferred from the selection of CSI-RS resources. Further, the selection of N out of N_{TRP} CSI-RS resources may be reported via N_{TRP}-bit bitmap to the network device (such as, in CSI part 1). Additionally, if a restricted configuration (gNB-configured via higher-layer signaling) where N=N_{TRP} is supported, the N_{TRP}-bit bitmap is not reported when the restriction is configured;
Ltot: a sum of values of parameters comprised in a parameter combination;
max (Ln): the maximum value of parameters comprised in a parameter combination.

Principles and implementations of the present disclosure will be described in detail below with reference to the figures.

### Example Environment

FIG. 1A illustrates an example communication network 100 in which embodiments of the present disclosure can be implemented. The communication network 100 includes a network device 120-1 and an optionally network device 120-2 (collectively or individually referred to as network devices 120). For purpose of discussion, the network device 120-1 is referred to as the first network device 120-1, and the network device 120-2 is referred to as the second network device 120-2. Further, the first network device 120-1 and the second network device 120-2 can communicate with each other. The network device 120 can provide services to a terminal device 110.

It is to be understood that the number of devices and their connections shown in FIG. 1A are only for the purpose of illustration without suggesting any limitation. The communication environment 100 may include any suitable number of devices configured to implementing example embodiments of the present disclosure. In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In the environment network 100, a link from the network devices 120 (such as, a first network device 120-1 or the second network device 120-2) to the terminal device 110 is referred to as a DL, while a link from the terminal device 110 to the network devices 120 (such as, a first network device 120-1 or the second network device 120-2) is referred to as an UL. In DL, the first network device 120-1 or the second network device 120-2 is a transmitting (TX) device (or a transmitter) and the terminal device 110 is a receiving (RX) device (or a receiver). In UL, the terminal device 110 is a transmitting TX device (or a transmitter) and the first network device 120-1 or the second network device 120-2 is a RX device (or a receiver).

In addition, in order to support multi-TRP and/or multi-panel, the network device 120 may be equipped with one or more TRPs. For example, the network device 120 may be coupled with multiple TRPs in different geographical locations to achieve better coverage. In one specific example embodiment, the first network device 120-1 is equipped with the first TRP 130-1 and the second TRP 130-2. Alternatively, in another specific example embodiment, the first network device 120-1 and the second network device 120-2 are equipped with the first TRP 130-1 and the second 130-2, respectively.

In some embodiments, the first TRP 130-1 and the second TRP 130-2 are associated with different control resource set pools (CORESET pools). For example, the first TRP 130-1 is associated with a first control resource set pool while the second TRP 130-2 is associated with a second control resource set pool.

Further, both a single TRP (also referred to as single TCI) mode and multi-TRP (also referred to as multi-TCI) mode are supported by the specific embodiment of FIG. 1A. Specifically, in case of the single TRP mode, the terminal device 110 communicates with the network via the first TRP 130-1/second TRP 130-2, and the transmission is performed based on the first/second control resource set pool, and one TCI state accordingly. Similarly, in case of the multi-TRP mode, the terminal device 110 communicates with the network via the first TRP 130-1 and the second TRP 130-2, and the transmission is performed based on the first and second control resource set pool, and two TCI state accordingly.

Further, both a single DCI and multi-DCI mode are supported in communication network 100. As illustrated in FIG. TA, when a single DCI mode is applied, the terminal device 110 receives a single DCI message from the first TRP 130-1. It should be understood that the single DCI message also may be received from the second TRP 130-2. Alternatively, when a multi-DCI mode is applied, the terminal device 110 receives two DCI messages from the first TRP 130-1 and the second TRP 130-2, respectively.

It should be understood that the number of TRPs comprised in the communication network 100 may be larger than two. As illustrated in the FOG. TA, the communication network 100 may further additionally comprise the TRP 130-3 and 130-4, and any of the TRP 130-3 and 130-4 may be equipped to the first network device 120-1 or the second network device 120-2.

Further, the network device(s) 120 may provide one or more serving cells and the first TRP 130-1 and the second TRP 130-2 may be included in a same serving cell or different serving cells. In other words, both an inter-cell transmission and an intra-cell transmission are supported by the specific example of FIG. TA.

FIG. 1B shows an example scenario of the communication network 100 as shown in FIG. TA. In the specific example of FIG. 1B, the first TRP 130-1 and the second TRP 130-2 are included in a same serving cell 140. In this event, the multi-TRP transmission is performed as an intra-cell transmission.

FIG. 1C shows another example scenario of the communication network 100 as shown in FIG. TA. In the specific example of FIG. 1C, the first TRP 130-1 and the second TRP 130-2 are included in different serving cells 140-1 and 140-2. In this event, the multi-TRP transmission is performed as an inter-cell transmission.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the numbers of devices (i.e., the terminal device 110, the network device 120, the TRP 130 and the cell 140) and their connection relationships and types shown in FIGS. TA to 1C are only for the purpose of illustration without suggesting any limitation. The communication network 100 may include any suitable numbers of devices adapted for implementing embodiments of the present disclosure.

### Example Processes

It is to be understood that the operations at the terminal device 110 and the network device 120 should be coordinated. In other words, the network device 120 and the terminal device 110 should have common understanding about configurations, parameters and so on. Such common understanding may be implemented by any suitable interactions between the network device 120 and the terminal device 110 or both the network device 120 and the terminal device 110 applying the same rule/policy. In the following, although some operations are described from a perspective of the terminal device 110, it is to be understood that the corresponding operations should be performed by the network device 120. Similarly, although some operations are described from a perspective of the network device 120, it is to be understood that the corresponding operations should be performed by the terminal device 110. Merely for brevity, some of the same or similar contents are omitted here.

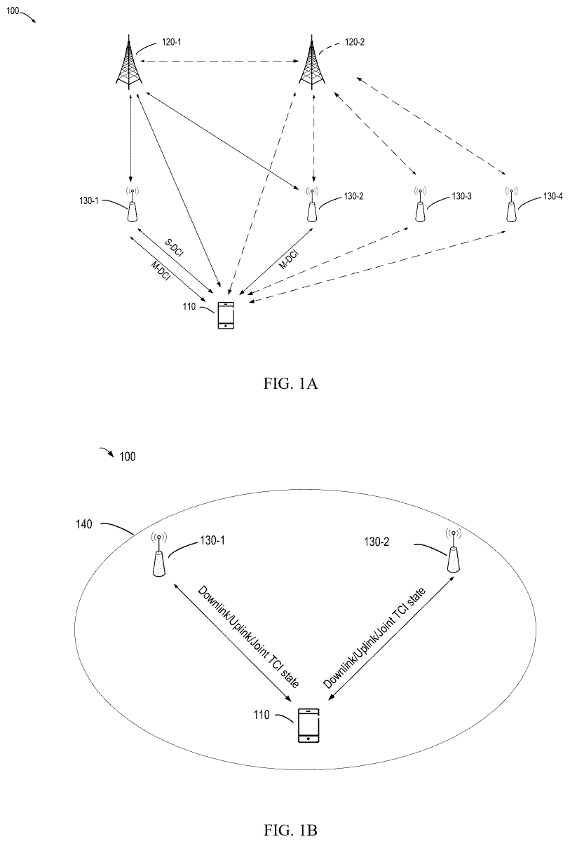

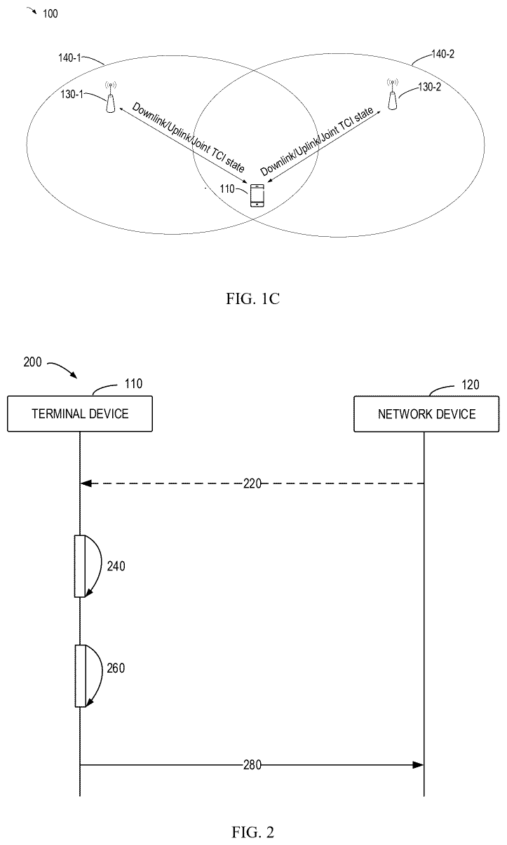

Reference is made to FIG. 2, which illustrates a signaling flow 200 of communication in accordance with some embodiments of the present disclosure. For the purposes of discussion, the signaling flow 200 will be discussed with reference to FIG. TA, for example, by using the terminal device 110 and the network device 120.

In operation, the terminal device 110 determines 240 a bitmap of CSI-RS resource and a first parameter combination, where the first parameter combination corresponds to a first number of CSI-RS resources and a first parameter set for codebook, and the bitmap of CSI-RS resource indicates a second number of CSI-RS resources selected by the terminal device 110.

Next, the terminal device 110 determines 260 a second parameter set for codebook based at least in part on a first parameter aggregation, where the first parameter aggregation is determined based on the first parameter combination and the bitmap of CSI-RS resource. After that, the terminal device 110 transmits 280 a report indicating at least one codebook indicator to the network device based at least in part on the second parameter set.

According to the present discourse, by determining a first parameter aggregation based on the first parameter combination and the bitmap of CSI-RS resource, the reported at least one codebook indicator may be determined based on a new parameter set (i.e., the second parameter set corresponding to the first parameter aggregation) rather than the first parameter set. Therefore, the overhead for reporting the at least one codebook indicator may be reduced.

In some embodiments, if the second number is same with the first number, the first parameter aggregation may be the same with the first parameter combination. For example, if the first parameter combination is {L1, L2, L3}, the first parameter aggregation is determined to be {L1, L2, L3}. In this event, the second parameter set is the same with the first parameter set.

Alternatively, in some embodiments, if the second number is smaller than the first number, the first parameter aggregation may be a subset of the first parameter combination. For example, if the first parameter combination is {L1, L2, L3}, the first parameter aggregation may be one of the following: {L1}, {L2}, {L3}, {L1, L2}, {L1, L3}, {L2, L3}. In this event, the second parameter set may result a lower overhead compared with the first parameter set.

In summary, the second parameter set may be the same with or different from the first parameter set. In view of this, the terminal device 110 may comprise more information in the report, such that the network device 120 may well understand the parameter set associated with the reported codebook indicator(s). In some embodiments, the report further may indicate at least one of the following:
the second parameter set,
the first parameter set, or
whether the first parameter set or the second parameter set is used by the terminal device for determining the at least one codebook indicator.

In some embodiments, the report may be a CSI report, and the more information is comprised in CSI part 1.

In the example of FIG. 2, the terminal device 110 at least needs to determine the first parameter aggregation, and the first parameter sets and/or the second parameter sets. In the following, details about how to determine the first parameter aggregation, and the first parameter sets and/or the second parameter sets will be discussed.

Determinations on the first and second parameter sets will be discussed first. In legacy solution, designs about parameter combinations and parameter sets are made separately. However, there are some correlations between the parameter combinations and parameter sets. In other words, there may be multiple pre-configured parameter sets supported by the wireless system, while each parameter combination may be only supported part of the multiple pre-configured parameter sets.

In view of this, in some embodiments, each parameter combination may be linked with a plurality of parameter sets (may be a subset of the total supported parameter sets). In some embodiments, one parameter combination may be linked with one parameter set. Alternatively, one parameter combination may be linked with more than one parameter set.

Further, these linkages may be defined as a default configuration by the communication organization (such as 3GPP), or pre-defined by the network operator or service provider. In this way, no additional signaling exchanging between the terminal device 110 and the network device 120 is needed.

Alternatively, in some embodiments, these linkages may be dynamically or semi-statically configured. For example, either the terminal device 110 or the network device 120 may determine these linkages and then inform these linkages to the other device.

By establishing the linkages between the parameter combinations and parameter sets, once the parameter combination is determined, the terminal device 110 may select/determine corresponding parameter sets.

Reference is now made to FIG. 3, which illustrates example linkages 300 between parameter combinations/parameter aggregation and parameter sets. In the specific example of FIG. 3, the parameter combination is {Lₙ} combination and the parameter set is {pᵥ, β} set.

In some embodiments, if the linkage indicates a one-to-one mapping (i.e., a predefined association between the first parameter combination and the first parameter set), once the first parameter combination is determined, the terminal device 110 may determine the first parameter combination directly.

Alternatively, in some embodiments, if the linkage indicates a one-to-more mapping, the terminal device 110 may further select the first parameter set from the first plurality of parameter sets. In this event, the first parameter set may be one of the following:
the first one of the first plurality of parameter sets,
the last one of the first plurality of parameter sets, or
a parameter set of the first plurality of parameter sets which results in a maximum payload size of the at least one codebook indicator.

Alternatively or in addition to the pre-defined linkage, the first parameter set also may be determined by the network device 120. Specifically, the network device 120 may transmit a codebook configuration indicating that the first parameter set corresponds to the first parameter combination to the terminal device 110. The codebook configuration may be generated by the network device 120 independently from or based on a pre-defined linkage.

According to the above example processes, the first parameter set may be properly determined if needed.

The nature of the first parameter aggregation is a parameter combination. In view of this, similar with the first parameter combination, the first parameter aggregation may be linked with a second plurality of parameter sets comprising the second parameter set, and the second parameter set is determined from the second plurality of parameter sets by the terminal device 110 based on the linkages.

In some embodiments, the if the linkage indicates a one-to-one mapping (i.e., a predefined association between the first parameter aggregation and the second parameter set), once the first parameter aggregation is determined, the terminal device 110 may determine the first parameter aggregation directly.

Alternatively, in some embodiments, if the linkage indicates a one-to-more mapping, the terminal device 110 may further select the second parameter set from the second plurality of parameter sets. In this event, the second parameter set is determined to be one of the followings:
the first one of the second plurality of parameter sets,
the last one of the second plurality of parameter sets,
a parameter set of the second plurality of parameter sets with a minimum difference to the first parameter set (i.e., the set with value of parameters ({pᵥ, β}, {M, β}, or {β}) nearest to (and/or no larger than) the first parameter set); or
a parameter set of the second plurality of parameter sets which results in a maximum payload size of the at least one codebook indicator (i.e., the set with value of parameters which leads to the maximum payload and no larger than the maximum payload corresponding to the first combination/the first number of CSI-RS resources/the first parameter set).

Alternatively or in addition to the pre-defined linkage, the second parameter set also may be determined by the network device 120. Specifically, the network device 120 transmits a codebook configuration indicating that the second parameter set corresponds to the first parameter aggregation to the terminal device 110. The codebook configuration may be generated by the network device 120 independently from or based on a pre-defined linkage.

Alternatively, or in addition, in some embodiments, the second parameter set is determined further based on restrictions on at least one of the second plurality of parameter sets or the second number of CSI-RS resources.

In one specific embodiment, the second parameter set may be configured (from the second plurality of parameter sets) by the network device 120 (via such as an RRC), wherein the second parameter set may be configured to be linked to first parameter aggregation (i.e., the subset of first combination, e.g. corresponding to a second combination which is same with the subset of first combination with excluding value 0).

In some embodiments, the parameter second set may be predetermined based on a fixed linkage with the subset of the first parameter combination (i.e., the first parameter aggregation) or may be predetermined based on the configured first parameter combination and the first parameter set. For example, there is only one parameter set in the second plurality of parameter sets or there is only one parameter set corresponding to the configured first parameter combination and/or the first parameter and/or the value of the bitmap for TRP selection.

According to the above example description, the second parameter set may be properly determined. In the following, more details about how to determine the first parameter aggregation will be discussed.

In some embodiments, the terminal device 110 may be configured with more than one parameter combination. In some embodiments, the more than one parameter combination may be associated with the first number N_{TRP}. In some embodiments, the number of values in each one of the more than one parameter combination may be the first number N_{TRP}. In some embodiments, the terminal device 110 may determine or report a first parameter combination from the more than one parameter combination. In some embodiments, the number of values in the first parameter combination may be the first number N_{TRP}. In some embodiments, the terminal device 110 may be configured with one parameter combination (for example, the first parameter combination), wherein the number of values in the one parameter combination may be the first number N_{TRP}.

In some embodiments, the terminal device 110 may determine or report the bitmap of CSI-RS resource. In some embodiments, the terminal device 110 may determine the first parameter aggregation or the subset of the first parameter combination based on the first parameter combination and/or the bitmap of CSI-RS resource. In some embodiments, the terminal device 110 may be configured with a first parameter set (for example, {pᵥ, β}, {M, β}, or {β}) associated with or corresponding to the first parameter combination.

In some embodiments, the first parameter combination may be represented as {L1, L2, L3, L4}. For example, number of values in the first parameter combination may be 4 or the first number N_{TRP}=4.

In some embodiments, the first parameter aggregation may be determined as {L1, L2, L3, L4}, and the terminal device 110 may determine or report the at least one codebook indicator based on the first parameter aggregation and the first parameter set associated with the first parameter combination {L1, L2, L3, L4}. In some embodiments, the first parameter aggregation may be determined as {L1, L2, L3, 0} or {L1, L2, L3}, and the terminal device 110 may determine or report the at least one codebook indicator based on the first parameter aggregation and a parameter set associated with parameter combination {L1, L2, L3}.

In some embodiments, the first parameter aggregation may be determined as {L1, L2, 0, L4} or {L1, L2, L4}, and the terminal device 110 may determine or report the at least one codebook indicator based on the first parameter aggregation and a parameter set associated with parameter combination {L1, L2, L4}.

In some embodiments, the first parameter aggregation may be determined as {L1, 0, L3, L4} or {L1, L3, L4}, and the terminal device 110 may determine or report the at least one codebook indicator based on the first parameter aggregation and a parameter set associated with parameter combination {L1, L3, L4}.

In some embodiments, the first parameter aggregation may be determined as {0, L2, L3, L4} or {L2, L3, L4}, and the terminal device 110 may determine or report the at least one codebook indicator based on the first parameter aggregation and a parameter set associated with parameter combination {L2, L3, L4}.

In some embodiments, the first parameter aggregation may be determined as {L1, L2, 0, 0} or {L1, L2}, and the terminal device 110 may determine or report the at least one codebook indicator based on the first parameter aggregation and a parameter set associated with parameter combination {L1, L2}.

In some embodiments, the first parameter aggregation may be determined as {L1, 0, 0, L4} or {L1, L4}, and the terminal device 110 may determine or report the at least one codebook indicator based on the first parameter aggregation and a parameter set associated with parameter combination {L1, L4}.

In some embodiments, the first parameter aggregation may be determined as {0, 0, L3, L4} or {L3, L4}, and the terminal device 110 may determine or report the at least one codebook indicator based on the first parameter aggregation and a parameter set associated with parameter combination {L3, L4}.

In some embodiments, the first parameter aggregation may be determined as {L1, 0, L3, 0} or {L1, L3}, and the terminal device 110 may determine or report the at least one codebook indicator based on the first parameter aggregation and a parameter set associated with parameter combination {L1, L3}.

In some embodiments, the first parameter aggregation may be determined as {0, L2, L3, 0} or {L2, L3}, and the terminal device 110 may determine or report the at least one codebook indicator based on the first parameter aggregation and a parameter set associated with parameter combination {L2, L3}.

In some embodiments, the first parameter aggregation may be determined as {0, L2, 0, L4} or {L2, L4}, and the terminal device 110 may determine or report the at least one codebook indicator based on the first parameter aggregation and a parameter set associated with parameter combination {L2, L4}.

In some embodiments, the first parameter aggregation may be determined as {L1, 0, 0, 0} or {L1}, and the terminal device 110 may determine or report the at least one codebook indicator based on the first parameter aggregation and a parameter set associated with parameter combination {L1} or {6}.

In some embodiments, the first parameter aggregation may be determined as {0, L2, 0, 0} or {L2}, and the terminal device 110 may determine or report the at least one codebook indicator based on the first parameter aggregation and a parameter set associated with parameter combination {L2} or {6}.

In some embodiments, the first parameter aggregation may be determined as {0, 0, L3, 0} or {L3}, and the terminal device 110 may determine or report the at least one codebook indicator based on the first parameter aggregation and a parameter set associated with parameter combination {L3} or {6}.

In some embodiments, the first parameter aggregation may be determined as {0, 0, 0, L4} or {L4}, and the terminal device 110 may determine or report the at least one codebook indicator based on the first parameter aggregation and a parameter set associated with parameter combination {L4} or {6}.

In some embodiments, the first parameter combination may be represented as {L1, L2, L3}(For example, number of values in the first parameter combination may be 3 or the first number N_{TRP}=3). In some embodiments, the first parameter aggregation may be determined as {L1, L2, L3}, and the terminal device 110 may determine or report the at least one codebook indicator based on the first parameter aggregation and the first parameter set associated with the first parameter combination {L1, L2, L3}.

In some embodiments, the first parameter aggregation may be determined as {L1, L2, 0} or {L1, L2}, and the terminal device 110 may determine or report the at least one codebook indicator based on the first parameter aggregation and a parameter set associated with parameter combination {L1, L2}.

In some embodiments, the first parameter aggregation may be determined as {L1, 0, L3} or {L1, L3}, and the terminal device 110 may determine or report the at least one codebook indicator based on the first parameter aggregation and a parameter set associated with parameter combination {L1, L3}.

In some embodiments, the first parameter aggregation may be determined as {0, L2, L3} or {L2, L3}, and the terminal device 110 may determine or report the at least one codebook indicator based on the first parameter aggregation and a parameter set associated with parameter combination {L2, L3}.

In some embodiments, the first parameter aggregation may be determined as {L1, 0, 0} or {L1}, and the terminal device 110 may determine or report the at least one codebook indicator based on the first parameter aggregation and a parameter set associated with parameter combination {L1} or {6}.

In some embodiments, the first parameter aggregation may be determined as {0, L2, 0} or {L2}, and the terminal device 110 may determine or report the at least one codebook indicator based on the first parameter aggregation and a parameter set associated with parameter combination {L2} or {6}.

In some embodiments, the first parameter aggregation may be determined as {0, 0, L3} or {L3}, and the terminal device 110 may determine or report the at least one codebook indicator based on the first parameter aggregation and a parameter set associated with parameter combination {L3} or {6}.

In some embodiments, the first parameter combination may be represented as {L1, L2}. For example, number of values in the first parameter combination may be 2 or the first number N_{TRP}=2.

In some embodiments, the first parameter aggregation may be determined as {L1, L2}, and the terminal device 110 may determine or report the at least one codebook indicator based on the first parameter aggregation and the first parameter set associated with the first parameter combination {L1, L2}.

In some embodiments, the first parameter aggregation may be determined as {L1, 0} or {L1}, and the terminal device 110 may determine or report the at least one codebook indicator based on the first parameter aggregation and a parameter set associated with parameter combination {L1} or {4} or {6}.

In some embodiments, the first parameter aggregation may be determined as {0, L2} or {L2}, and the terminal device 110 may determine or report the at least one codebook indicator based on the first parameter aggregation and a parameter set associated with parameter combination {L2} or {4} or {6}.

In some embodiments, the first parameter combination is represented as a vector with N elements, where a value of each element may be one of {1, 2, 4, 6}. For example, the first parameter combination is {L1, L2, L3 L4}. Further, the bitmap of CSI-RS resource also may be represented as a vector with N elements, where a value of each element may be either “0” or “1”. For example, the bitmap of CSI-RS resource is [1, 1, 0, 0].

In some embodiments, the first parameter aggregation may be calculated by the following operations: performing a logical operation on the first parameter combination and the bitmap of CSI-RS resource, where in the bitmap of CSI-RS resource is used as a mask of the first parameter combination; only retaining the non-element in the result of the logical operation (i.e., removing the zero from the result of the logical operation) to obtain the first parameter aggregation. For example, the result of the logical operation of {L1, L2, L3 L4} and [1, 1, 0, 0] is {L1, L2, 0, 0}. The first parameter aggregation is {L1, L2} accordingly.

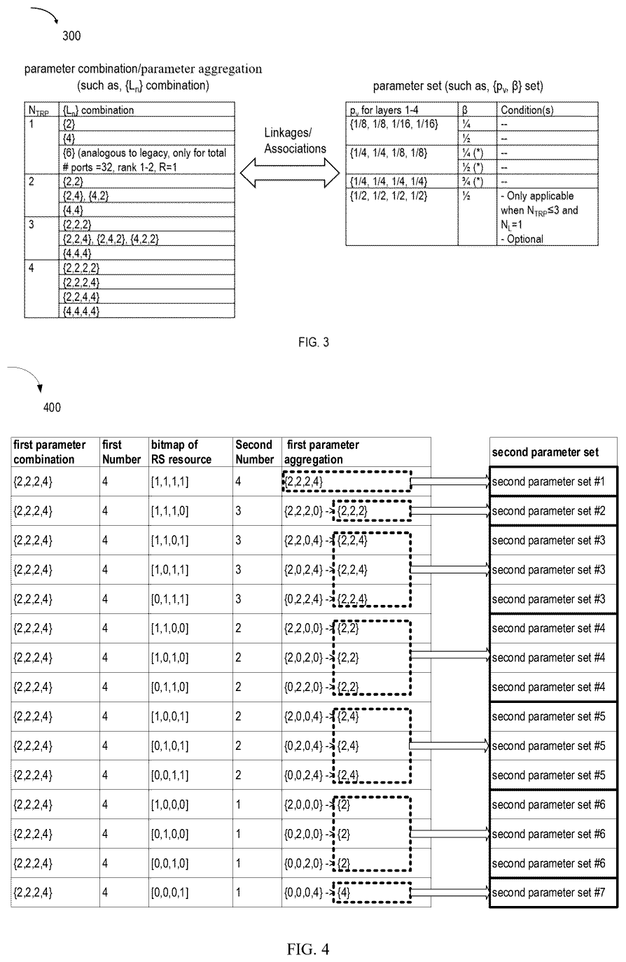

Merely for better understanding, reference is now made to FIG. 4, which illustrates an example correspondence 400 among the codebook-related parameters. In the specific example of FIG. 4, the first combination is {2, 2, 2, 4}. As illustrated in FIG. 4,
if the second number is four, the first parameter aggregation is the same with the first parameter combination (i.e., {2, 2, 2, 4}) and the second parameter set is the same with the first parameter set;
if the second number is three and the bitmap of the CSI-RS resource is [1, 1, 1, 0], the first parameter aggregation is {2, 2, 2}, and the second parameter set is determined from a plurality of parameter sets associated with the parameter combination of {2, 2, 2};
if the second number is three and the bitmap of the CSI-RS resource is one of [1, 1, 0, 1], [1, 0, 1, 1] and [0, 1, 1, 1], the first parameter aggregation is {2, 2, 4}, and the second parameter set is determined from a plurality of parameter sets associated with the parameter combination of {2, 2, 4};
if the second number is two and the bitmap of the CSI-RS resource is one of [1, 1, 0, 0], [1, 0, 1, 0] and [0, 1, 1, 0], the first parameter aggregation is {2, 2}, and the second parameter set is determined from a plurality of parameter sets associated with the parameter combination of {2, 2};
if the second number is two and the bitmap of the CSI-RS resource is one of [1, 0, 0, 1], [0, 1, 0, 1] and [0, 0, 1, 1], the first parameter aggregation is {2, 4}, and the second parameter set is determined from a plurality of parameter sets associated with the parameter combination of {2, 4};
if the second number is one and the bitmap of the CSI-RS resource is one of [1, 0, 0, 1], [0, 1, 0, 0] and [0, 0, 1, 0], the first parameter aggregation is {2}, and the second parameter set is determined from a plurality of parameter sets associated with the parameter combination of {2}; or
if the second number is one and the bitmap of the CSI-RS resource is [0, 0, 0, 1]the first parameter aggregation is {4}, and the second parameter set is determined from a plurality of parameter sets associated with the parameter combination of {4}.

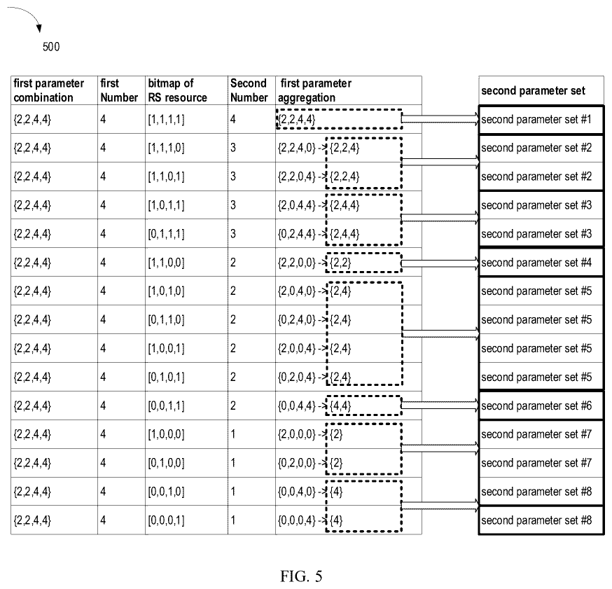

Another example correspondence 500 among the codebook-related parameters is illustrated in FIG. 5. In the specific example of FIG. 5, the first combination is {2, 2, 4, 4}. As illustrated in FIG. 5,
if the second number is four, the first parameter aggregation is the same with the first parameter combination (i.e., {2, 2, 4, 4}), and the second parameter set is the same with the first parameter set;
if the second number is three and the bitmap of the CSI-RS resource is [1, 1, 1, 0] or [1, 1, 0, 1], the first parameter aggregation is {2, 2, 4}, and the second parameter set is determined from a plurality of parameter sets associated with the parameter combination of {2, 2, 4};
if the second number is three and the bitmap of the CSI-RS resource is [1, 0, 1, 1] or [0, 1, 1, 1], the first parameter aggregation is a replaced parameter combination, the second parameter set is determined from a plurality of parameter sets associated with the replaced parameter combination, and the replaced parameter combination is one of {2, 2, 4, 4}, {2, 2, 2, 4}, {4, 4, 4} and {2, 2, 4};
if the second number is two and the bitmap of the CSI-RS resource is [1, 1, 0, 0], the first parameter aggregation is {2, 2}, and the second parameter set is determined from a plurality of parameter sets associated with the parameter combination of {2, 2};
if the second number is two and the bitmap of the CSI-RS resource is one of [1, 0, 1, 0], [0, 1, 1, 0], [1, 0, 0, 1] and [0, 1, 0, 1], the first parameter aggregation is {2, 4}, and the second parameter set is determined from a plurality of parameter sets associated with the parameter combination of {2, 4};
if the second number is two and the bitmap of the CSI-RS resource is [0, 0, 1, 1], the first parameter aggregation is {4, 4}, and the second parameter set is determined from a plurality of parameter sets associated with the parameter combination of {4, 4};
if the second number is one and the bitmap of the CSI-RS resource is [1, 0, 0, 0] or [0, 1, 0, 0], the first parameter aggregation is {2}, and the second parameter set is determined from a plurality of parameter sets associated with the parameter combination of {2}; or
if the second number is one and the bitmap of the CSI-RS resource is [0, 0, 1, 0] or [0, 0, 0, 1], the first parameter aggregation is {4}, and the second parameter set is determined from a plurality of parameter sets associated with the parameter combination of {4}.

It is to be understood that the above examples illustrated in FIGS. 4 and 5 are only for the purpose of illustration without suggesting any limitations. According to the key concept taught by FIGS. 4 and 5, similar processes may be operated for other parameter combinations.

In some embodiments, if a parameter aggregation determined based on the first parameter combination and the bitmap of CSI-RS resource is not supported by the terminal device, the second parameter set is determined to be one of the following:
the first parameter set,
a parameter set corresponding to a parameter combination supported by the terminal device, wherein a sum of values of parameters comprised in the parameter combination is equal to a sum of values of parameters comprised in the parameter aggregation determined based on the first parameter combination and the bitmap of CSI-RS resource, or
a parameter set corresponding to a parameter combination supported by the terminal device, wherein a number of parameters comprised in the parameter combination is the same with a number of parameters comprised in the parameter aggregation determined based on the first parameter combination and the bitmap of CSI-RS resource.

Additionally, in some embodiments, if a parameter aggregation determined based on the first parameter combination and the bitmap of CSI-RS resource is {2, 4, 4}(which is not supported in current wireless communication system), the second parameter set is determined to be one of the following:
the first parameter set,
a parameter set corresponding to a parameter combination of {2, 2, 2, 4},
a parameter set corresponding to a parameter combination of {4, 4, 4}, or
a parameter set corresponding to a parameter combination of {2, 2, 4}.

For better understanding, still refer to FIG. 5. In the specific embodiment of FIG. 5, in case that the bitmap of the CSI-RS resource is [1, 0, 1, 1] or [0, 1, 1, 1], the first parameter aggregation determined based on the first parameter combination and the bitmap of the CSI-RS resource is {2, 4, 4}. In this event, the parameter aggregation is determined to be {2, 2, 2, 4}, {4, 4, 4} or {2, 2, 4}.

According to current agreement, parameter value “6” is supported only in case of the parameter combination {6}(i.e., the number of TRPs is one). In view of this, further improvement may be proposed for the scenario where the second number is one. Specifically, if the second number is one, the first parameter aggregation comprises one parameter, a value of the parameter is a minimum between a maximum allowed value and a sum of values of parameters comprised in the first parameter combination. In summary, if the first combination is {2, 2}, the first parameter aggregation is determined to be {4}, else the first parameter aggregation is {6}.

As one specific embodiments, in case that second number is one (i.e., single-TRP), the first aggregation for first vector may be determined to be min (Ltot, 6), wherein Ltot may be

$${\sum }_{n = 1}^{{N}_{T R P}} {L}_{n}$$

corresponding to the first parameter combination.

Specifically, in case that the number of ports=32 for one CSI-RS resource, and rank is 1 or 2 and R=1, the terminal device 110 may report the first aggregation for first vector to be min(Ltot, 6) or the subset of the first combination which is determined based on the first combination and the bitmap for CSI-RS resource selection (i.e. corresponding {Ln} with n-th bit=1). If N_{TRP}=2, and first combination is {2, 2}, the first aggregation for first vector may be 4. If N_{TRP}=2, and first combination is {2, 4}, the first aggregation for first vector may be {6}.

According to the above processes, the overhead for reporting the at least one codebook indicator is reduced. According to some embodiments of the present discourse, related parameter associated with reporting the codebook indicator(s) may be configured by the network device. As illustrated in FIG. 2, the terminal device 110 may receive 220 at least one codebook configuration from the network device 120, where the codebook configuration(s) may indicate a plurality of parameters to be used by the terminal device 110, the plurality of parameters comprising at least one of the following:
a first parameter indicating a maximum number of CSI-RS resources, be represented as N_{TRP};
a second parameter indicating a number of the at least one parameter combination, be represented as N_{L};
a third parameter indicating the at least one parameter combination, be represented as {Lₙ} combinations;
a fourth parameter indicating a plurality of supported parameter sets, such as, the values of {pᵥ, β} parameter sets, or
a fifth parameter indicating whether selection of at least one CSI-RS resource is enabled.

The above first to five parameters may be indicated jointly or separately. Further, the above first to five parameters may be comprised in a same message or more than two different messages. Some examples about how to indicate the above parameters are discussed in the following.

In some embodiments, the first, second, third, fourth and fifth parameters are indicated separately.

Alternatively, in some embodiments, the second and the third parameters are indicated jointly, while the first, fourth and fifth parameters are indicated separately.

Alternatively, in some embodiments, the first, second and the third parameters are indicated jointly, while the fourth and fifth parameters are indicated separately.

Alternatively, in some embodiments, the first, second, third and the fourth parameters are indicated jointly, while the fifth parameter is indicated separately.

Alternatively, in some embodiments, the second, third and the fourth parameters are indicated jointly, while the first and fifth parameters are indicated separately.

In the following, some example codebook configurations are described as below.

In one specific embodiment, the at least one codebook configuration (or at least one IE for codebook configuration) may comprise at least one of:
A first field (e.g. NumberOfCSI-RS-Resources): used for configuring the maximum number of CSI-RS resources (N_{TRP});
   In some embodiments, the bitsize of the first filed may be 2 bits and N_{TRP} E {1, 2, 3, 4};
A second field (e.g. NumberOfLnCombinations): used for configuring number of first combinations (N_{L});
   In some embodiments, the bitsize of the second filed may be 1 bit or 2 bits, and N_{L} ∈{1, 2, 4};
A third field (e.g. LnCombination): used for configuring the N_{L} first combinations {Lₙ};
   In some embodiments, the number of candidates for first combinations corresponding to one value of N_{TRP} may be represented as N_{L,N}_{_{TRP}}. In some embodiments, N_{L,N}_{_{TRP}} ∈{3, 4, 5} or {3, 4, 5, 6, 7, 8};
   In some embodiments, the bitsize of the third field may be X1=

$$⌈ {log}_{2} ( {max}_{{n}_{TRP} ∈ {N}_{TRP}} C ( {N}_{L , {n}_{TRP}} , {N}_{L} ) ) ⌉ ;$$

Alternatively, the bitsize of the third field may be N_{L,N}_{_{TRP}};
In some embodiments, the third filed may be a bitmap indication. In this case, the above second field may be absent;
A fourth field (e.g. PvBetaCombination or MBetaCombination) used for configuring the values for {pᵥ, β};
   There may be six candidates values for {pᵥ, β} as illustrated in FIG. 3.
   The bitsize of the fourth field may be X2=3, or X2=6 (if the fourth field is represented to be a bitmap corresponding to the six candidate values);
A fifth field (e.g. CSI-RSResourceSelection) used for configuring whether CSI-RS resource selection is enabled or not, and/or configure restriction of CSI-RS resource selection.
   The field of CSI-RSResourceSelection may be a bit string with a bitsize of 4 or NumberOfCSI-RS-Resources;
   This field indicates restriction of TRP selection. The most significant (left) bit represents the first CSI-RS resource in the first plurality of CSI-RS resources, and the second most significant (left) bit represents the second CSI-RS resource in the first plurality of CSI-RS resources and so on. The bit(s) set to one (or zero) indicates the corresponding CSI-RS resource can be selected or not by the terminal device 110;
   As one specific embodiment, if the bit string is {1, 1, 0, 1}, selection or not of the first/second/fourth CSI-RS resource can be reported in CSI. The third CSI-RS resource should always be selected.
   As another specific embodiment, if the bit string is {0, 0, 0, 0}, no TRP selection is allowed (i.e., no field of bitmap for TRP selection in CSI report);

Blow is an example configuration of codebook configurations.

| CodebookConfigCJT-r18 ::= | SEQUENCE { | |
|---|---|---|
| codebookType | CHOICE { | |
| subType | CHOICE { | |
| typeII-r18 | SEQUENCE { | |
| | NumberOfCSI-RS-Resources | ENUMERATED {n1, n2, n3, n4} or INTEGER (1..4), |
| | CSI-RSResourceSelection | ENUMERATED {enabled}, |
| | Or CSI-RSResourceSelection | BIT STRING (SIZE (4 or |
| | | NumberOfCSI-RS-Resources)), |
| NumberOfLnCombinations | ENUMERATED {n1, n2, n4}, | |
| | LnCombinationList ::= | SEQUENCE (SIZE(1..maxNumTRPs/ |
| | | NumberOfCSI-RS-Resources)) OF LnCombination |
| | PvBetaCombinationList ::= | SEQUENCE (SIZE(1..maxNumTRPs/ Number |
| | | OfCSI-RS-Resources)) OF PvBetaCombina- |

tion

| | |
|---|---|
| codebookSubsetRestrictionCJT ::= | SEQUENCE (SIZE(1..maxNumTRPs/ |
| | NumberOfCSI-RS-Resources)) OF n1-n2- |

codebookSubsetRestriction

| | |
|---|---|
| typeII-RI-RestrictionCJT | BIT STRING (SIZE(4)) |

```
      },
      typeII-PortSelection-r18 SEQUENCE {
```

| NumberOfCSI-RS-Resources | ENUMERATED {n1, n2, n3, n4}, | |
|---|---|---|
| NumberOfLnCombinations | ENUMERATED {n1, n2, n4}, | |
| AlphaCombinationList ::= | SEQUENCE (SIZE(1..maxNumTRPs/ NumberOfCSI-RS-Resources)) OF AlphaCombination | |
| | MBetaCombinationList ::= | SEQUENCE (SIZE(1..maxNumTRPs/ |
| | | NumberOfCSI-RS-Resources)) OF MBetaCombina- |

tion

| | |
|---|---|
| valueOfN | ENUMERATED {n2, n4}, |

```
        typeII-PortSelectionRI-RestrictionCJT BIT STRING (SIZE (4))
      }
    },
  numberOfPMI-SubbandsPerCQI-Subband-r16 INTEGER (1..2),
  }
}
```

| | |
|---|---|
| LnCombination | BIT STRING (SIZE (X1)) |
| PvBetaCombination | BIT STRING (SIZE (X2)) |
| AlphaCombination | BIT STRING (SIZE (X3)) |
| MBetaCombination | BIT STRING (SIZE (X4)) |
| n1-n2-codebookSubsetRestriction-r16 | CHOICE { |
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

}.

In some embodiments, field subType may indicate whether the codebook is based on release 16 Type II or release 17 Type II port selection.

In some embodiments, field NumberOfCSI-RS-Resources is an enumerated of {n1, n2, n3, n4}, wherein this field indicates the number of CSI-RS resources in the first plurality of CSI-RS resources (i.e. value of N_{TRP}). Alternatively, in some embodiments, field NumberOfCSI-RS-Resources is an enumerated of {n2, n3, n4}, wherein this field indicates the number of CSI-RS resources in the first plurality of CSI-RS resources (i.e., value of N_{TRP}). If absent, the number is 1 (i.e., N_{TRP}=).

In some embodiments, field CSI-RSResourceSelection is an enumerated of {enabled}, wherein if present, this field indicates TRP selection is enabled. If the field is absent, TRP selection is disabled. Alternatively, in some embodiments, field CSI-RSResourceSelection is an enumerated of {enabled, disabled}, wherein this field indicates whether TRP selection is enabled or disabled.

Alternatively, in some embodiments, field CSI-RSResourceSelection is a bit string with a bitsize of 4-bits or NumberOfCSI-RS-Resources. Further, this field indicates restriction of TRP selection. The most significant (left) bit represents the first CSI-RS resource in the first plurality of CSI-RS resources, and the second most significant (left) bit represents the second CSI-RS resource in the first plurality of CSI-RS resources and so on. The bit(s) set to one (or zero) indicates the corresponding CSI-RS resource can be selected or not by the terminal device. As one specific embodiments, if the bit string is {1, 1, 0, 1}, selection or not of the first/second/fourth CSI-RS resource can be reported in CSI. The third CSI-RS resource is always selected. As another specific embodiments, if the bit string is {0, 0, 0, 0}, no TRP selection (i.e., no field of bitmap for TRP selection in CSI).

In another specific embodiment, the at least one codebook configuration (or at least one IE for codebook configuration) may comprise at least one of:
A first field (e.g., NumberOfCSI-RS-Resources): used for configuring the maximum number of CSI-RS resources (N_{TRP});
   In some embodiments, the bitsize of the first filed may be 2 bits and N_{TRP} ∈{1, 2, 3, 4).
A second field (e.g., LnCombination) used for configuring the number of first combinations (N_{L}) and the N_{L} first combinations {Lₙ};
   In some embodiments, the bitsize of the second field size may be N_{L,N}_{_{TRP}} or

$${max}_{{n}_{TRP} ∈ {N}_{TRP}} ( {N}_{L , {n}_{TRP}} ) ,$$

n_{TRP ∈{}1, . . . N_{TRP}};
   the second field may be a Bitmap indication;
   The number of bits considering the maximum number of supported candidates for combination (e.g., 5 candidates for N_{TRP}=3);
   For example, indicated by LnCombination, which is a bit string with a bitsize of X5. As one example, X5=5;
A fourth field (e.g. PvBetaCombination or MBetaCombination) used for configuring the values for {pᵥ, β};
   There may be six candidates values for {pᵥ, β} as illustrated in FIG. 3;
   The bitsize of the fourth field may be X2=3 or X2=6 (if the fourth field is represented to be a bitmap corresponding to the six candidate values);
A fifth field (e.g., CSI-RSResourceSelection) used for configuring whether CSI-RS resource selection is enabled or not, and/or configure restriction of CSI-RS resource selection.

Blow is an example configuration of codebook configurations.

Configuration example 2 (joint NL, Ln)

| CodebookConfigCJT-r18 ::= | SEQUENCE { | |
|---|---|---|
| codebookType | CHOICE { | |
| subType | CHOICE { | |
| typeII-r18 | SEQUENCE { | |
| | NumberOfCSI-RS-Resources | ENUMERATED {n1, n2, n3, n4} or INTEGER (1..4), |
| | CSI-RSResourceSelection | ENUMERATED {enabled}, |
| | Or CSI-RSResourceSelection | BIT STRING (SIZE (4 or |
| | | NumberOfCSI-RS-Resources)), |
| | LnCombination | BIT STRING (SIZE (X5 (e.g. X5=5))), |
| | PvBetaCombinationList ::= | SEQUENCE (SIZE(1..maxNumTRPs/ |
| | | NumberOfCSI-RS-Resources)) OF |

PvBetaCombination

| | |
|---|---|
| codebookSubsetRestrictionCJT ::= | SEQUENCE (SIZE(1..maxNumTRPs/ |
| | NumberOfCSI-RS-Resources)) OF n1-n2- |

codebookSubsetRestriction

| | |
|---|---|
| typeII-RI-RestrictionCJT | BIT STRING (SIZE(4)) |

```
      },
      typeII-PortSelection-r18 SEQUENCE {
```

| NumberOfCSI-RS-Resources | ENUMERATED {n1, n2, n3, n4}, | |
|---|---|---|
| NumberOfLnCombinations | ENUMERATED {n1, n2, n4}, | |
| AlphaCombination | BIT STRING (SIZE (X6)), | |
| | MBetaCombinationList ::= | SEQUENCE (SIZE(1..maxNumTRPs/ |
| | | NumberOfCSI-RS-Resources)) OF |

MBetaCombination

| | |
|---|---|
| valueOfN | ENUMERATED {n2, n4}, |

```
        typeII-PortSelectionRI-RestrictionCJT BIT STRING (SIZE (4))
      }
    },
  numberOfPMI-SubbandsPerCQI-Subband-r16 INTEGER (1..2),
  }
}
```

| | |
|---|---|
| PvBetaCombination | BIT STRING (SIZE (X2)) |
| MBetaCombination | BIT STRING (SIZE (X4)) |
| n1-n2-codebookSubsetRestriction-r16 | CHOICE { |
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

}.

In one specific embodiment, the at least one codebook configuration (or at least one IE for codebook configuration) may comprise at least one of:
A first field (e.g. Combination) used for configuring the maximum number of CSI-RS resources (N_{TRP}) and associated combination for first vector and number of combinations for first vector;
   the first field may be Bitmap indication;
   The number of bits considering the maximum number of supported candidates of N_{TRP} and combination (e.g., total 16 candidates for N_{TRP}=1, 2, 3, 4);
A fourth field (e.g., PvBetaCombination or MBetaCombination) used for configuring the values for {pᵥ, β};
   There may be six candidates values for {pᵥ, β} as illustrated in FIG. 3;
   The bitsize of the fourth field may be X2=3 or X2=6 (if the fourth field is represented to be a bitmap corresponding to the six candidate values);
A fifth field (e.g., CSI-RSResourceSelection) used for configuring whether CSI-RS resource selection is enabled or not, and/or configure restriction of CSI-RS resource selection.

Blow is an example configuration of codebook configurations.

Configuration example 3 (joint NTRP, NL, Ln)

| CodebookConfigCJT-r18 ::= | SEQUENCE { | |
|---|---|---|
| codebookType | CHOICE { | |
| subType | CHOICE { | |
| typeII-r18 | SEQUENCE { | |
| | CSI-RSResourceSelection | ENUMERATED {enabled}, |
| | Or CSI-RSResourceSelection | BIT STRING (SIZE (4 or |
| | | NumberOfCSI-RS-Resources)), |
| | Combination | BIT STRING (SIZE (X7, (e.g. X7=16))), |
| | PvBetaCombinationList ::= | SEQUENCE (SIZE(1..maxNumTRPs/ |
| | | NumberOfCSI-RS-Resources)) OF |

PvBetaCombination

| | |
|---|---|
| codebookSubsetRestrictionCJT ::= | SEQUENCE (SIZE(1..maxNumTRPs/ |
| | NumberOfCSI-RS-Resources)) OF n1-n2- |

codebookSubsetRestriction

| | |
|---|---|
| typeII-RI-RestrictionCJT | BIT STRING (SIZE(4)) |

},

| typeII-PortSelection-r18 | SEQUENCE { | |
|---|---|---|
| NumberOfCSI-RS-Resources | ENUMERATED {n1, n2, n3, n4}, | |
| NumberOfLnCombinations | ENUMERATED {n1, n2, n4}, | |
| Combination | BIT STRING (SIZE (X8)), | |
| | MBetaCombinationList ::= | SEQUENCE (SIZE(1..maxNumTRPs/ |
| | | NumberOfCSI-RS-Resources)) OF |

MBetaCombination

| | |
|---|---|
| valueOfN | ENUMERATED {n2, n4}, |

```
        typeII-PortSelectionRI-RestrictionCJT BIT STRING (SIZE (4))
      }
    },
  numberOfPMI-SubbandsPerCQI-Subband-r16 INTEGER (1..2),
  }
}
```

| | |
|---|---|
| PvBetaCombination | BIT STRING (SIZE (X2)) |
| MBetaCombination | BIT STRING (SIZE (X4)) |
| n1-n2-codebookSubsetRestriction-r16 | CHOICE { |
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

}.

In one specific embodiment, the at least one codebook configuration (or at least one IE for codebook configuration) may comprise at least one of:
A first field (e.g., JointCombination) used for configuring the maximum number of CSI-RS resources (N_{TRP}) and associated combination for first vector and number of combinations for first vector and corresponding {pᵥ, β};
   The first field may be Bitmap indication;
   The number of bits considering the maximum number of supported candidates (e.g., For N_{TRP}≤=3, total 12 candidates for combination for first vector and 6 candidates for {pᵥ, β} and N_{TRP}=4, total 4 candidates for combination for first vector and 5 candidates for {pᵥ, β});
   As one specific embodiments, the first field is represented to be a bit string of JointCombination with a bitsize of X9. As one example, 8<=X9<=92;
A fifth field (e.g., CSI-RSResourceSelection) used for configuring whether CSI-RS resource selection is enabled or not, and/or configure restriction of CSI-RS resource selection.

Blow is an example configuration of codebook configurations.

Configuration example 4 (joint NTRP, NL, Ln and {pᵥ, β})

| CodebookConfigCJT-r18 ::= | SEQUENCE { | |
|---|---|---|
| codebookType | CHOICE { | |
| subType | CHOICE { | |
| typeII-r18 | SEQUENCE { | |
| | CSI-RSResourceSelection | ENUMERATED {enabled}, |
| | Or CSI-RSResourceSelection | BIT STRING (SIZE (4 or |
| | | NumberOfCSI-RS-Resources)), |
| | JointCombination | BIT STRING (SIZE (X9, (e.g. 8<=X9<=92))), |
| | codebookSubsetRestrictionCJT ::= | SEQUENCE (SIZE(1..maxNumTRPs/ |
| | | NumberOfCSI-RS-Resources)) OF n1-n2- |

codebookSubsetRestriction

| | |
|---|---|
| typeII-RI-RestrictionCJT | BIT STRING (SIZE(4)) |

},

| | |
|---|---|
| typeII-PortSelection-r18 | SEQUENCE { |
| NumberOfCSI-RS-Resources | ENUMERATED {n1, n2, n3, n4}, |
| NumberOfLnCombinations | ENUMERATED {n1, n2, n4}, |
| JointCombination | BIT STRING (SIZE (X10)), |
| valueOfN | ENUMERATED {n2, n4}, |

```
        typeII-PortSelectionRI-RestrictionCJT BIT STRING (SIZE (4))
      }
    },
  numberOfPMI-SubbandsPerCQI-Subband-r16 INTEGER (1..2),
  }
}
```

| | |
|---|---|
| n1-n2-codebookSubsetRestriction-r16 | CHOICE { |
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

}.

In one specific embodiment, the at least one codebook configuration (or at least one IE for codebook configuration) may comprise at least one of:
A first field (e.g., NumberOfCSI-RS-Resources): used for configuring the maximum number of CSI-RS resources (N_{TRP});
   In some embodiments, the bitsize of the first filed may be 2 bits and N_{TRP}∈{1, 2, 3, 4};
A second field (e.g., ParamCombination): used for configuring at least one combination for first vector and number of combinations for first vector and corresponding {pᵥ, β};
   The second field may be a Bitmap indication;
   The number of bits considering the maximum number of supported candidates for combination (e.g., For N_{TRP}=4, 4 candidates for combination for first vector, and 5 candidates for {pᵥ, β}→total 20. For N_{TRP}<=3, if for a given value of N_{TRP}, same value of Ltot corresponding to same {pᵥ, β}, then 3*6 candidates in total;
   As one specific embodiments, the first field is represented to be a bit string of JointCombination with a bitsize of X11. As one example, 8<=X11<=20 or 30;
A fifth field (e.g., CSI-RSResourceSelection) used for configuring whether CSI-RS resource selection is enabled or not, and/or configure restriction of CSI-RS resource selection.

Additionally, in case that at least one parameter combination is comprised the codebook configuration, the above discussed first parameter combination may be determined from the at least one parameter combination by the terminal device 110.

Additionally, in some embodiments, all of the at least one parameter combination corresponds to the first number of CSI-RS resources. In one specific embodiments, the at least one parameter combination may be selected from {2, 2, 2, 2}, {2, 2, 2, 4}, {2, 2, 4, 4} and {4, 4, 4, 4}, i.e., the first number is 4.

In another specific embodiments, the at least one parameter combination may be selected from {2, 2, 2}, {2, 2, 4}, {2, 4, 2}, {4, 2, 2} and {4, 4, 4}, i.e., the first number is 3.

In a further specific embodiments, the at least one parameter combination may be selected from {2, 2}, {2, 4}, {4, 2} and {4, 4}, i.e., the first number is 2.

In a further specific embodiments, the at least one parameter combination may be selected from {2}, {4}, {6}, i.e., the first number is 1.

Alternatively, the at least one parameter combination comprises at least two parameter combination corresponding to two different numbers of CSI-RS resources, such as, a first parameter combination corresponding to a first number of CSI-RS resources, and a further parameter combination corresponding to a third number of CSI-RS resources different from the first number of CSI-RS resources.

According to the above processes, how to report codebook indicator may be well configured by the network device 120.

In legacy solution, in order to reducing interference and saving power, in case of Type-II codebook refinement for CJT MTRP, the codebook subset restriction (CBSR) scheme (at least for restricting SD basis selection) is fully reused for each of the RRC-configured N_{TRP} CSI-RS resources, which enables CSI-RS-resource-specific SD beam group restriction.

In some embodiments of the present disclosure, the CBSR configuration may be supported. Specifically, at least one of the CSI-RS resource in the first number of CSI-RS resources is configured with a CBSR configuration. Additionally, in some embodiments, it is supported that CBSR configuration may be configured as a common configuration shared by at least two CSI-RS resources, or be configured as a specific configuration specific to a specific CSI-RS resource.

Additionally, in some embodiments, it is supported that the CBSR configuration may be configured to be off for a CSI-RS resource.

In order to enable or disable to the CBSR configuration more technically reasonable, according to some embodiments of the present disclosure, whether to apply the CBSR configuration is determined based on the second number of the CSI-RS resources (i.e., signal TRP mode or multi-TRP mode), and an indication indicating whether the CBSR configuration is configured to be off.

In some embodiments, if the second number is larger than one, the CBSR configuration is ignored if the CBSR configuration is configured to be off. In this way, in case that the terminal device 110 is in CJT (usually when the terminal device 110 is at the edges of the cells), the communication quality of transmission is guaranteed.

Alternatively, in some other embodiments, if the second number is equal to one, the CBSR configuration is applied even if the CBSR configuration is configured to be off. In this way, the interference caused by the terminal device 110 is minimized.

As one specific embodiment, the terminal device 110 may be configured with a list of codebook subset restriction for a first plurality of CSI-RS resources, where a CBSR configuration of a first CSI-RS resource in the first plurality of CSI-RS resources may be configured with CBSR off. In this specific embodiment, in response to the first CSI-RS resource is included in the second plurality of CSI-RS resources (i.e., the first CSI-RS resource is selected by the terminal device 110) and the second number of CSI-RS resources is larger than 1 (i.e., multi-TRP mode), the CBSR configuration corresponding to the first CSI-RS resource is ignored if CBSR off is enabled. Alternatively, in response to the first CSI-RS resource is included in the second plurality of CSI-RS resources (i.e., the first CSI-RS resource is selected by the terminal device 110) and the second number of CSI-RS resources in the second plurality of CSI-RS resources is 1 (i.e., single TRP mode), the CBSR corresponding to the first CSI-RS resource is applied, i.e., the field for CBSR off is ignored.

Further, in some other embodiments, amplitude restriction also may be supported, and the amplitude restriction also may be configured as a common configuration or a specific configuration. Additionally, similar with the discussions about CBSR configuration, the amplitude restriction also may be configured to be off, and further whether apply the amplitude restriction also may be determined based on the second number of the CSI-RS resources (i.e., signal TRP mode or multi-TRP mode), and an indication indicating whether the amplitude restriction is configured to be off. Merely for brevity, the same or similar contents are omitted here.

In some embodiments, the same rank restriction may be applied across N_{TRP} CSI-RS resources.

Merely for better understanding, some specific embodiments will be illustrated with reference to FIG. 2.

In some embodiments, the terminal device 110 may be configured 220 with at least one combination (e.g. N_{L} combinations) for first vector (e.g. {Lₙ} for the first and/or second codebook type, or {a,} for the second codebook type) in one codebook configuration, the terminal device 110 may determine/report 240 a first combination from the at least one combination for first vector and determine 240 a bitmap for CSI-RS resource selection based on a first plurality of CSI-RS resources, wherein the first combination may be associated with a first number of CSI-RS resources (in a first plurality of CSI-RS resources).

In some embodiments, the at least one combination of {Ln} may be associated with the first number of CSI-RS resources (TRPs, i.e., same value of N_{TRP}) or may be associated with at least one value of the first number (e.g., associated with different values of N_{TRP}).

In some embodiments, a second number of CSI-RS resources (i.e., N TRPs, 1<=N<=N_{TRP} in a second plurality of CSI-RS resources) may be based on the bitmap for CSI-RS resource selection.

Next, the terminal device 110 may determine/report 260 at least one codebook indicator based on a set of parameters (e.g. {pᵥ, β} for first codebook type, {M, β} or {β} for second codebook type), and the set of parameters may be determined based on or linked to a first aggregation for first vector, wherein the first aggregation for first vector may be determined based on the first combination and the bitmap for CSI-RS resource selection (e.g. the second number of CSI-RS resources, the index(es) of the selected CSI-RS resource(s)).

In some embodiments, the first aggregation for first vector may be a full set (same as) or a subset of the first combination.

In some embodiments, in response to the second number is same with the first number, a first set of parameters linked to (associated with) the first combination associated with the first number of CSI-RS resources may be applied (the terminal device may determine/report at least one codebook indicators based on the first set of parameters and the first combination associated with the first number of CSI-RS resources).

In some embodiments, the first set of parameters may be configured by network device 120 (via such as an RRC) or may be predetermined based on a fixed linkage with the first combination.

In some embodiments, the first set of parameters may be one of a first plurality of sets of parameters, wherein the first plurality of sets of parameters may be supported/allowed sets of parameters which can be linked to the first combination.

In some embodiments, the number of sets in the first plurality of sets of parameters may be {1, 2, 3, 4, 5, 6}.

Alternatively, in some embodiments, in response to the second number is less than the first number, a second set of parameters linked to (associated with) a subset of the first combination associated with the second number of CSI-RS resources may be applied (the terminal device may determine/report at least one codebook indicators based on the second set of parameters and the subset of the first combination associated with the second number of CSI-RS resources).

In some embodiments, the subset of the first combination may be determined based on the first combination and the bitmap for CSI-RS resource selection (e.g., the second number of CSI-RS resources and/or the index(es) of the CSI-RS resource(s) selected from the first plurality of CSI-RS resources).

In some embodiments, the subset of the first combination may be within the supported set of combinations for first vector, e.g., represented as a second combination.

In some embodiments, the second set of parameters may be one of a second plurality of sets of parameters, wherein the second plurality of sets of parameters may be supported/allowed sets of parameters which can be linked to the second combination.

In some embodiments, the number of sets in the second plurality of sets of parameters may be {1, 2, 3, 4, 5, 6}.

As one specific embodiments, the terminal device 110 may be configured with a set of combinations linked with sets of parameters and/or restriction for CSI-RS resource selection. In this event, the terminal device 110 may report the CSI-RS resource selection and/or the second set of parameters based on the set of combinations linked with sets of parameters and/or restriction of CSI-RS resource selection.

Specifically, when the candidate number of aggregations (e.g. represented as S) is smaller than the number of aggregations in a whole set (e.g. 2ⁿ−1), the terminal device 110 may indicate the first aggregation and/or associated set of parameters and/or CSI-RS resource selection based on the first S aggregations, wherein the candidate number of aggregation may be based on restriction for CSI-RS resource selection or configuration of linked parameters between combination and set of parameters.

### Example Methods

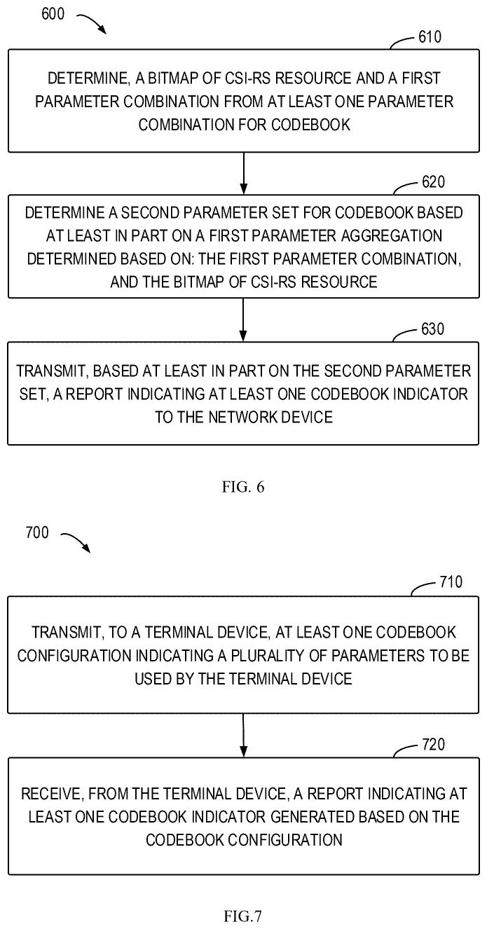

FIG. 6 illustrates a flowchart of a communication method 600 implemented at a terminal device in accordance with some embodiments of the present disclosure. For the purpose of discussion, the method 600 will be described from the perspective of the terminal device 110 in FIG. TA.

At block 610, the terminal device determines, a bitmap of CSI-RS resource and a first parameter combination from at least one parameter combination for codebook, the first parameter combination corresponding to a first number of RS resources and a first parameter set for codebook, the bitmap of RS resource indicating a second number of CSI-RS resources selected by the terminal device.

At block 620, the terminal device determines a second parameter set for codebook based at least in part on a first parameter aggregation determined based on: the first parameter combination, and the bitmap of CSI-RS resource.

At block 630, the terminal device transmits, based at least in part on the second parameter set, a report indicating at least one codebook indicator to the network device.

In some example embodiments, if the second number is same with the first number, the first parameter aggregation is the same with the first parameter combination, and the second parameter set is the same with the first parameter set.

In some example embodiments, the first parameter combination is associated with a first plurality of parameter sets comprising the first parameter set, and wherein, the first parameter set is determined from the first plurality of parameter sets by the terminal device based on one of the following: a predefined association between the first parameter combination and the first parameter set, a codebook configuration received from the network device, the codebook configuration indicating that the first parameter set corresponds to the first parameter combination.

In some example embodiments, if the second number is smaller than the first number, the first parameter aggregation is a subset of the first parameter combination.

In some example embodiments, the first parameter aggregation is associated with a second plurality of parameter sets comprising the second parameter set, and the second parameter set is determined from the second plurality of parameter sets by the terminal device.

In some example embodiments, the second parameter set is determined from the second plurality of parameter sets based on one of the followings: a predefined association between the first parameter aggregation and the second parameter set, a codebook configuration received from the network device, the codebook configuration indicating that the second parameter set corresponds to the first parameter aggregation, or restrictions on at least one of the second plurality of parameter sets or the second number of CSI-RS resources.

In some example embodiments, the second parameter set is determined to be one of the followings: the first one of the second plurality of parameter sets, the last one of the second plurality of parameter sets, a parameter set of the second plurality of parameter sets with a minimum difference to the first parameter set, or a parameter set of the second plurality of parameter sets which results in a maximum payload size of the at least one codebook indicator.

In some example embodiments, if the second number is one, the first parameter aggregation comprises one parameter, a value of the parameter is a minimum between a maximum allowed value and a sum of values of parameters comprised in the first parameter combination.

In some example embodiments, if the first combination is {2, 2}, the first parameter aggregation is {4}, else the first parameter aggregation is {6}.

In some example embodiments, the report further indicates at least one of the following: the second parameter set, the first parameter set, or whether the first parameter set or the second parameter set is used by the terminal device for determining the at least one codebook indicator.

In some example embodiments, determining the second parameter set comprises: if a parameter aggregation determined based on the first parameter combination and the bitmap of CSI-RS resource is not supported by the terminal device, the second parameter set is determined to be one of the following: the first parameter set, a parameter set corresponding to a parameter combination supported by the terminal device, wherein a sum of values of parameters comprised in the parameter combination is equal to a sum of values of parameters comprised in the parameter aggregation determined based on the first parameter combination and the bitmap of CSI-RS resource, or a parameter set corresponding to a parameter combination supported by the terminal device, wherein a number of parameters comprised in the parameter combination is the same with a number of parameters comprised in the parameter aggregation determined based on the first parameter combination and the bitmap of CSI-RS resource.

In some example embodiments, if a parameter aggregation determined based on the first parameter combination and the bitmap of CSI-RS resource is {2, 4, 4}, the second parameter set is determined to be one of the following: the first parameter set, a parameter set corresponding to a parameter combination of {2, 2, 2, 4}, a parameter set corresponding to a parameter combination of {4, 4, 4}, or a parameter set corresponding to a parameter combination of {2, 2, 4}.

In some example embodiments, if the first combination is {2, 2, 2, 4}, and wherein, if the second number is four, the first parameter aggregation is the same with the first parameter combination and the second parameter set is the same with the first parameter set; if the second number is three and the bitmap of the CSI-RS resource is [1, 1, 1, 0], the first parameter aggregation is {2, 2, 2}, and the second parameter set is determined from a plurality of parameter sets associated with the parameter combination of {2, 2, 2}; if the second number is three and the bitmap of the CSI-RS resource is one of [1, 1, 0, 1], [1, 0, 1, 1] and [0, 1, 1, 1], the first parameter aggregation is {2, 2, 4}, and the second parameter set is determined from a plurality of parameter sets associated with the parameter combination of {2, 2, 4}; if the second number is two and the bitmap of the CSI-RS resource is one of [1, 1, 0, 0], [1, 0, 1, 0] and [0, 1, 1, 0], the first parameter aggregation is {2, 2}, and the second parameter set is determined from a plurality of parameter sets associated with the parameter combination of {2, 2}; if the second number is two and the bitmap of the CSI-RS resource is one of [1, 0, 0, 1], [0, 1, 0, 1] and [0, 0, 1, 1], the first parameter aggregation is {2, 4}, and the second parameter set is determined from a plurality of parameter sets associated with the parameter combination of {2, 4}; if the second number is one and the bitmap of the CSI-RS resource is one of [1, 0, 0, 1], [0, 1, 0, 0] and [0, 0, 1, 0], the first parameter aggregation is {2}, and the second parameter set is determined from a plurality of parameter sets associated with the parameter combination of {2}; or if the second number is one and the bitmap of the CSI-RS resource is [0, 0, 0, 1] the first parameter aggregation is {4}, and the second parameter set is determined from a plurality of parameter sets associated with the parameter combination of {4}.

In some example embodiments, if the first combination is {2, 2, 4, 4}, and wherein, if the second number is four, the first parameter aggregation is the same with the first parameter combination, and the second parameter set is the same with the first parameter set; if the second number is three and the bitmap of the CSI-RS resource is [1, 1, 1, 0] or [1, 1, 0, 1], the first parameter aggregation is {2, 2, 4}, and the second parameter set is determined from a plurality of parameter sets associated with the parameter combination of {2, 2, 4}; if the second number is three and the bitmap of the CSI-RS resource is [1, 0, 1, 1] or [0, 1, 1, 1], the first parameter aggregation is a replaced parameter combination, the second parameter set is determined from a plurality of parameter sets associated with the replaced parameter combination, and the replaced parameter combination is one of {2, 2, 4, 4}, {2, 2, 2, 4}, {4, 4, 4} and {2, 2, 4}; if the second number is two and the bitmap of the CSI-RS resource is [1, 1, 0, 0], the first parameter aggregation is {2, 2}, and the second parameter set is determined from a plurality of parameter sets associated with the parameter combination of {2, 2}; if the second number is two and the bitmap of the CSI-RS resource is one of [1, 0, 1, 0], [0, 1, 1, 0], [1, 0, 0, 1] and [0, 1, 0, 1], the first parameter aggregation is {2, 4}, and the second parameter set is determined from a plurality of parameter sets associated with the parameter combination of {2, 4}; if the second number is two and the bitmap of the CSI-RS resource is [0, 0, 1, 1], the first parameter aggregation is {4, 4}, and the second parameter set is determined from a plurality of parameter sets associated with the parameter combination of {4, 4}; if the second number is one and the bitmap of the CSI-RS resource is [1, 0, 0, 0] or [0, 1, 0, 0], the first parameter aggregation is {2}, and the second parameter set is determined from a plurality of parameter sets associated with the parameter combination of {2}; or if the second number is one and the bitmap of the CSI-RS resource is [0, 0, 1, 0] or [0, 0, 0, 1], the first parameter aggregation is {4}, and the second parameter set is determined from a plurality of parameter sets associated with the parameter combination of {4}.

In some example embodiments, the processor is further configured to cause the terminal device to: receive, from the network device, at least one codebook configuration indicating a plurality of parameters to be used by the terminal device, the plurality of parameters comprising at least one of the following: a first parameter indicating a maximum number of CSI-RS resources, a second parameter indicating a number of the at least one parameter combination, a third parameter indicating the at least one parameter combination, a fourth parameter indicating a plurality of supported parameter sets, or a fifth parameter indicating whether selection of at least one CSI-RS resource is enabled.

In some example embodiments, the first, second, third, fourth and fifth parameters are indicated separately; the second and the third parameters are indicated jointly, while the first, fourth and fifth parameters are indicated separately; the first, second and the third parameters are indicated jointly, while the fourth and fifth parameters are indicated separately; the first, second, third and the fourth parameters are indicated jointly, while the fifth parameter is indicated separately; or the second, third and the fourth parameters are indicated jointly, while the first and fifth parameters are indicated separately.

In some example embodiments, all of the at least one parameter combination corresponds to the first number of CSI-RS resources, or the at least one parameter combination comprises a further parameter combination corresponding to a third number of CSI-RS resources different from the first number of CSI-RS resources.

In some example embodiments, at least one of the CSI-RS resource in the first number of CSI-RS resources is configured with a codebook subset restriction (CBSR) configuration, and the processor is further configured to cause the terminal device to: determine whether to apply the CBSR configuration based on: the second number of the CSI-RS resources, and an indication indicating whether the CBSR configuration is configured to be off.

In some example embodiments, determining whether to apply the CBSR configuration comprises: if the second number is larger than one, the CBSR configuration is ignored if the CBSR configuration is configured to be off, or if the second number is equal to one, the CBSR configuration is applied even if the CBSR configuration is configured to be off.

FIG. 7 illustrates a flowchart of a communication method 700 implemented at a network device in accordance with some embodiments of the present disclosure. For the purpose of discussion, the method 700 will be described from the perspective of the network device 120 in FIG. TA.

At block 710, the network device transmits, to a terminal device, at least one codebook configuration indicating a plurality of parameters to be used by the terminal device, the plurality of parameters comprising: a first parameter indicating a maximum number of CSI-RS resources, a second parameter indicating a number of at least one parameter combination for codebook, a third parameter indicating the at least one parameter combination for codebook, a fourth parameter indicating a plurality of supported parameter sets for codebook, and a fifth parameter indicating whether selection of at least one CSI-RS resource is enabled.

At block 720, the network device receives, from the terminal device, a report indicating at least one codebook indicator generated based on the codebook configuration.

In some example embodiments, the first, second, third, fourth and fifth parameters are indicated separately; the second and the third parameters are indicated jointly, while the first, fourth and fifth parameters are indicated separately; the first, second and the third parameters are indicated jointly, while the fourth and fifth parameters are indicated separately; the first, second, third and the fourth parameters are indicated jointly, while the fifth parameter is indicated separately; or the second, third and the fourth parameters are indicated jointly, while the first and fifth parameters are indicated separately.

In some example embodiments, all of the at least one parameter combination corresponds to a same first number of CSI-RS resources, or the at least one parameter combination corresponds at least two different numbers of CSI-RS resources.

### Example Devices and Apparatuses

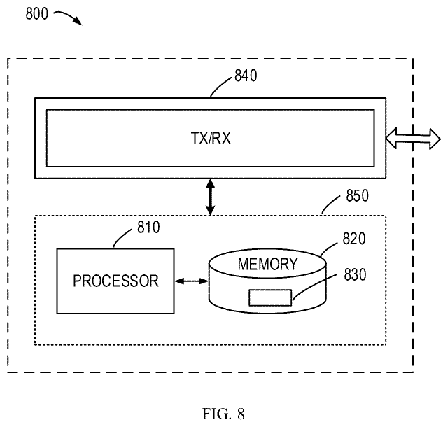

FIG. 8 is a simplified block diagram of a device 800 that is suitable for implementing embodiments of the present disclosure. The device 800 can be considered as a further example implementation of any of the devices as shown in FIG. 1A. Accordingly, the device 800 can be implemented at or as at least a part of the terminal device 110 or the network device 120.

As shown, the device 800 includes a processor 810, a memory 820 coupled to the processor 810, a suitable transceiver 840 coupled to the processor 810, and a communication interface coupled to the transceiver 840. The memory 810 stores at least a part of a program 830. The transceiver 840 may be for bidirectional communications or a unidirectional communication based on requirements. The transceiver 840 may include at least one of a transmitter 842 and a receiver 844. The transmitter 842 and the receiver 844 may be functional modules or physical entities. The transceiver 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

According to embodiments of the present disclosure, a terminal device comprising a circuitry is provided. The circuitry is configured to: determine, a bitmap of CSI-RS resource and a first parameter combination from at least one parameter combination for codebook, the first parameter combination corresponding to a first number of CSI-RS resources and a first parameter set for codebook, the bitmap of CSI-RS resource indicating a second number of CSI-RS resources selected by the terminal device; determine a second parameter set for codebook based at least in part on a first parameter aggregation determined based on: the first parameter combination, and the bitmap of CSI-RS resource; and transmit, based at least in part on the second parameter set, a report indicating at least one codebook indicator to the network device. According to embodiments of the present disclosure, the circuitry may be configured to perform any method implemented by the terminal device as discussed above.

According to embodiments of the present disclosure, a network device comprising a circuitry is provided. The circuitry is configured to: transmit, to a terminal device, at least one codebook configuration indicating a plurality of parameters to be used by the terminal device, the plurality of parameters comprising: a first parameter indicating a maximum number of CSI-RS resources, a second parameter indicating a number of at least one parameter combination for codebook, a third parameter indicating the at least one parameter combination for codebook, a fourth parameter indicating a plurality of supported parameter sets for codebook, and a fifth parameter indicating whether selection of at least one CSI-RS resource is enabled, receive, from the terminal device, a report indicating at least one codebook indicator generated based on the codebook configuration. According to embodiments of the present disclosure, the circuitry may be configured to perform any method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a terminal device comprising: a processor configured to cause the terminal device to: determine, a bitmap of CSI-RS resource and a first parameter combination from at least one parameter combination for codebook, the first parameter combination corresponding to a first number of CSI-RS resources and a first parameter set for codebook, the bitmap of CSI-RS resource indicating a second number of CSI-RS resources selected by the terminal device; determine a second parameter set for codebook based at least in part on a first parameter aggregation determined based on: the first parameter combination, and the bitmap of CSI-RS resource; and transmit, based at least in part on the second parameter set, a report indicating at least one codebook indicator to the network device.

In some embodiments, if the second number is same with the first number, the first parameter aggregation is the same with the first parameter combination, and the second parameter set is the same with the first parameter set.

In some embodiments, the first parameter combination is associated with a first plurality of parameter sets comprising the first parameter set, and wherein, the first parameter set is determined from the first plurality of parameter sets by the terminal device based on one of the following: a predefined association between the first parameter combination and the first parameter set, a codebook configuration received from the network device, the codebook configuration indicating that the first parameter set corresponds to the first parameter combination.

In some embodiments, if the second number is smaller than the first number, the first parameter aggregation is a subset of the first parameter combination.

In some embodiments, the first parameter aggregation is associated with a second plurality of parameter sets comprising the second parameter set, and the second parameter set is determined from the second plurality of parameter sets by the terminal device.

In some embodiments, the second parameter set is determined from the second plurality of parameter sets based on one of the followings: a predefined association between the first parameter aggregation and the second parameter set, a codebook configuration received from the network device, the codebook configuration indicating that the second parameter set corresponds to the first parameter aggregation, or restrictions on at least one of the second plurality of parameter sets or the second number of CSI-RS resources.

In some embodiments, the second parameter set is determined to be one of the followings: the first one of the second plurality of parameter sets, the last one of the second plurality of parameter sets, a parameter set of the second plurality of parameter sets with a minimum difference to the first parameter set, or a parameter set of the second plurality of parameter sets which results in a maximum payload size of the at least one codebook indicator.

In some embodiments, if the second number is one, the first parameter aggregation comprises one parameter, a value of the parameter is a minimum between a maximum allowed value and a sum of values of parameters comprised in the first parameter combination.

In some embodiments, if the first combination is {2, 2}, the first parameter aggregation is {4}, else the first parameter aggregation is {6}.

In some embodiments, the report further indicates at least one of the following: the second parameter set, the first parameter set, or whether the first parameter set or the second parameter set is used by the terminal device for determining the at least one codebook indicator.

In some embodiments, determining the second parameter set comprises: if a parameter aggregation determined based on the first parameter combination and the bitmap of CSI-RS resource is not supported by the terminal device, the second parameter set is determined to be one of the following: the first parameter set, a parameter set corresponding to a parameter combination supported by the terminal device, wherein a sum of values of parameters comprised in the parameter combination is equal to a sum of values of parameters comprised in the parameter aggregation determined based on the first parameter combination and the bitmap of CSI-RS resource, or a parameter set corresponding to a parameter combination supported by the terminal device, wherein a number of parameters comprised in the parameter combination is the same with a number of parameters comprised in the parameter aggregation determined based on the first parameter combination and the bitmap of CSI-RS resource.

In some embodiments, if a parameter aggregation determined based on the first parameter combination and the bitmap of CSI-RS resource is {2, 4, 4}, the second parameter set is determined to be one of the following: the first parameter set, a parameter set corresponding to a parameter combination of {2, 2, 2, 4}, a parameter set corresponding to a parameter combination of {4, 4, 4}, or a parameter set corresponding to a parameter combination of {2, 2, 4}.

In some embodiments, if the first combination is {2, 2, 2, 4}, and wherein, if the second number is four, the first parameter aggregation is the same with the first parameter combination and the second parameter set is the same with the first parameter set; if the second number is three and the bitmap of the CSI-RS resource is [1, 1, 1, 0], the first parameter aggregation is {2, 2, 2}, and the second parameter set is determined from a plurality of parameter sets associated with the parameter combination of {2, 2, 2}; if the second number is three and the bitmap of the CSI-RS resource is one of [1, 1, 0, 1], [1, 0, 1, 1] and [0, 1, 1, 1], the first parameter aggregation is {2, 2, 4}, and the second parameter set is determined from a plurality of parameter sets associated with the parameter combination of {2, 2, 4}; if the second number is two and the bitmap of the CSI-RS resource is one of [1, 1, 0, 0], [1, 0, 1, 0] and [0, 1, 1, 0], the first parameter aggregation is {2, 2}, and the second parameter set is determined from a plurality of parameter sets associated with the parameter combination of {2, 2}; if the second number is two and the bitmap of the CSI-RS resource is one of [1, 0, 0, 1], [0, 1, 0, 1] and [0, 0, 1, 1], the first parameter aggregation is {2, 4}, and the second parameter set is determined from a plurality of parameter sets associated with the parameter combination of {2, 4}; if the second number is one and the bitmap of the CSI-RS resource is one of [1, 0, 0, 1], [0, 1, 0, 0] and [0, 0, 1, 0], the first parameter aggregation is {2}, and the second parameter set is determined from a plurality of parameter sets associated with the parameter combination of {2}; or if the second number is one and the bitmap of the CSI-RS resource is [0, 0, 0, 1] the first parameter aggregation is {4}, and the second parameter set is determined from a plurality of parameter sets associated with the parameter combination of {4}.

In some embodiments, if the first combination is {2, 2, 4, 4}, and wherein, if the second number is four, the first parameter aggregation is the same with the first parameter combination, and the second parameter set is the same with the first parameter set; if the second number is three and the bitmap of the CSI-RS resource is [1, 1, 1, 0] or [1, 1, 0, 1], the first parameter aggregation is {2, 2, 4}, and the second parameter set is determined from a plurality of parameter sets associated with the parameter combination of {2, 2, 4}; if the second number is three and the bitmap of the CSI-RS resource is [1, 0, 1, 1] or [0, 1, 1, 1], the first parameter aggregation is a replaced parameter combination, the second parameter set is determined from a plurality of parameter sets associated with the replaced parameter combination, and the replaced parameter combination is one of {2, 2, 4, 4}, {2, 2, 2, 4}, {4, 4, 4} and {2, 2, 4}; if the second number is two and the bitmap of the CSI-RS resource is [1, 1, 0, 0], the first parameter aggregation is {2, 2}, and the second parameter set is determined from a plurality of parameter sets associated with the parameter combination of {2, 2}; if the second number is two and the bitmap of the CSI-RS resource is one of [1, 0, 1, 0], [0, 1, 1, 0], [1, 0, 0, 1] and [0, 1, 0, 1], the first parameter aggregation is {2, 4}, and the second parameter set is determined from a plurality of parameter sets associated with the parameter combination of {2, 4}; if the second number is two and the bitmap of the CSI-RS resource is [0, 0, 1, 1], the first parameter aggregation is {4, 4}, and the second parameter set is determined from a plurality of parameter sets associated with the parameter combination of {4, 4}; if the second number is one and the bitmap of the CSI-RS resource is [1, 0, 0, 0] or [0, 1, 0, 0], the first parameter aggregation is {2}, and the second parameter set is determined from a plurality of parameter sets associated with the parameter combination of {2}; or if the second number is one and the bitmap of the CSI-RS resource is [0, 0, 1, 0] or [0, 0, 0, 1], the first parameter aggregation is {4}, and the second parameter set is determined from a plurality of parameter sets associated with the parameter combination of {4}.

In some embodiments, the processor is further configured to cause the terminal device to: receive, from the network device, at least one codebook configuration indicating a plurality of parameters to be used by the terminal device, the plurality of parameters comprising at least one of the following: a first parameter indicating a maximum number of CSI-RS resources, a second parameter indicating a number of the at least one parameter combination, a third parameter indicating the at least one parameter combination, a fourth parameter indicating a plurality of supported parameter sets, or a fifth parameter indicating whether selection of at least one CSI-RS resource is enabled.

In some embodiments, the first, second, third, fourth and fifth parameters are indicated separately; the second and the third parameters are indicated jointly, while the first, fourth and fifth parameters are indicated separately; the first, second and the third parameters are indicated jointly, while the fourth and fifth parameters are indicated separately; the first, second, third and the fourth parameters are indicated jointly, while the fifth parameter is indicated separately; or the second, third and the fourth parameters are indicated jointly, while the first and fifth parameters are indicated separately.

In some embodiments, all of the at least one parameter combination corresponds to the first number of CSI-RS resources, or the at least one parameter combination comprises a further parameter combination corresponding to a third number of CSI-RS resources different from the first number of CSI-RS resources.

In some embodiments, at least one of the CSI-RS resource in the first number of CSI-RS resources is configured with a codebook subset restriction (CBSR) configuration, and the processor is further configured to cause the terminal device to: determine whether to apply the CBSR configuration based on: the second number of the CSI-RS resources, and an indication indicating whether the CBSR configuration is configured to be off.

In some embodiments, determining whether to apply the CBSR configuration comprises: if the second number is larger than one, the CBSR configuration is ignored if the CBSR configuration is configured to be off, or if the second number is equal to one, the CBSR configuration is applied even if the CBSR configuration is configured to be off.

In an aspect, it is proposed a network device comprising: a processor configured to cause the terminal device to: transmit, to a terminal device, at least one codebook configuration indicating a plurality of parameters to be used by the terminal device, the plurality of parameters comprising: a first parameter indicating a maximum number of CSI-RS resources, a second parameter indicating a number of at least one parameter combination for codebook, a third parameter indicating the at least one parameter combination for codebook, a fourth parameter indicating a plurality of supported parameter sets for codebook, and a fifth parameter indicating whether selection of at least one CSI-RS resource is enabled, receive, from the terminal device, a report indicating at least one codebook indicator generated based on the codebook configuration.

In some embodiments, the first, second, third, fourth and fifth parameters are indicated separately; the second and the third parameters are indicated jointly, while the first, fourth and fifth parameters are indicated separately; the first, second and the third parameters are indicated jointly, while the fourth and fifth parameters are indicated separately; the first, second, third and the fourth parameters are indicated jointly, while the fifth parameter is indicated separately; or the second, third and the fourth parameters are indicated jointly, while the first and fifth parameters are indicated separately.

In some embodiments, all of the at least one parameter combination corresponds to a same first number of CSI-RS resources, or the at least one parameter combination corresponds at least two different numbers of CSI-RS resources.

In an aspect, a terminal device comprises: at least one processor; and at least one memory coupled to the at least one processor and storing instructions thereon, the instructions, when executed by the at least one processor, causing the device to perform the method implemented by the terminal device discussed above.

In an aspect, a network device comprises: at least one processor; and at least one memory coupled to the at least one processor and storing instructions thereon, the instructions, when executed by the at least one processor, causing the device to perform the method implemented by the network device discussed above.

In an aspect, a computer readable medium having instructions stored thereon, the instructions, when executed on at least one processor, causing the at least one processor to perform the method implemented by the terminal device discussed above.

In an aspect, a computer readable medium having instructions stored thereon, the instructions, when executed on at least one processor, causing the at least one processor to perform the method implemented by the network device discussed above.

In an aspect, a computer program comprising instructions, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
a processor configured to cause the terminal device to:
determine, a bitmap of channel state information reference signal (CSI-RS) resource and a first parameter combination from at least one parameter combination for codebook, the first parameter combination corresponding to a first number of CSI-RS resources and a first parameter set for codebook, the bitmap of CSI-RS resource indicating a second number of CSI-RS resources selected by the terminal device;
determine a second parameter set for codebook based at least in part on a first parameter aggregation determined based on:
the first parameter combination, and
the bitmap of CSI-RS resource; and
transmit, based at least in part on the second parameter set, a report indicating at least one codebook indicator to the network device.

2. The terminal device of claim 1, wherein if the second number is same with the first number, the first parameter aggregation is the same with the first parameter combination, and the second parameter set is the same with the first parameter set.

3. The terminal device of claim 1 or 2, wherein the first parameter combination is associated with a first plurality of parameter sets comprising the first parameter set, and wherein,
the first parameter set is determined from the first plurality of parameter sets by the terminal device based on one of the following:
a predefined association between the first parameter combination and the first parameter set,
a codebook configuration received from the network device, the codebook configuration indicating that the first parameter set corresponds to the first parameter combination.

4. The terminal device of claim 1, wherein if the second number is smaller than the first number, the first parameter aggregation is a subset of the first parameter combination.

5. The terminal device of claim 1 or 4, wherein the first parameter aggregation is associated with a second plurality of parameter sets comprising the second parameter set, and the second parameter set is determined from the second plurality of parameter sets by the terminal device.

6. The terminal device of claim 5, wherein the second parameter set is determined from the second plurality of parameter sets based on one of the followings:
a predefined association between the first parameter aggregation and the second parameter set,
a codebook configuration received from the network device, the codebook configuration indicating that the second parameter set corresponds to the first parameter aggregation, or
restrictions on at least one of the second plurality of parameter sets or the second number of CSI-RS resources.

7. The terminal device of claim 5, wherein the second parameter set is determined to be one of the followings:
the first one of the second plurality of parameter sets,
the last one of the second plurality of parameter sets,
a parameter set of the second plurality of parameter sets with a minimum difference to the first parameter set, or
a parameter set of the second plurality of parameter sets which results in a maximum payload size of the at least one codebook indicator.

8. The terminal device of claim 1, wherein if the second number is one, the first parameter aggregation comprises one parameter, a value of the parameter is a minimum between a maximum allowed value and a sum of values of parameters comprised in the first parameter combination.

9. The terminal device of claim 1, wherein if the first combination is {2, 2}, the first parameter aggregation is {4}, else the first parameter aggregation is {6}.

10. The terminal device of claim 5, wherein the report further indicates at least one of the following:
the second parameter set,
the first parameter set, or
whether the first parameter set or the second parameter set is used by the terminal device for determining the at least one codebook indicator.

11. The terminal device of claim 1, wherein determining the second parameter set comprises:
if a parameter aggregation determined based on the first parameter combination and the bitmap of CSI-RS resource is not supported by the terminal device, the second parameter set is determined to be one of the following:
the first parameter set,
a parameter set corresponding to a parameter combination supported by the terminal device, wherein a sum of values of parameters comprised in the parameter combination is equal to a sum of values of parameters comprised in the parameter aggregation determined based on the first parameter combination and the bitmap of CSI-RS resource, or
a parameter set corresponding to a parameter combination supported by the terminal device, wherein a number of parameters comprised in the parameter combination is the same with a number of parameters comprised in the parameter aggregation determined based on the first parameter combination and the bitmap of CSI-RS resource.

12. The terminal device of claim 1, wherein if a parameter aggregation determined based on the first parameter combination and the bitmap of CSI-RS resource is {2, 4, 4}, the second parameter set is determined to be one of the following:
the first parameter set,
a parameter set corresponding to a parameter combination of {2, 2, 2, 4},
a parameter set corresponding to a parameter combination of {4, 4, 4}, or
a parameter set corresponding to a parameter combination of {2, 2, 4}.

13. The terminal device of claim 1, wherein if the first combination is {2, 2, 2, 4}, and wherein,
if the second number is four, the first parameter aggregation is the same with the first parameter combination and the second parameter set is the same with the first parameter set;
if the second number is three and the bitmap of the CSI-RS resource is [1, 1, 1, 0], the first parameter aggregation is {2, 2, 2}, and the second parameter set is determined from a plurality of parameter sets associated with the parameter combination of {2, 2, 2};
if the second number is three and the bitmap of the CSI-RS resource is one of [1, 1, 0, 1], [1, 0, 1, 1] and [0, 1, 1, 1], the first parameter aggregation is {2, 2, 4}, and the second parameter set is determined from a plurality of parameter sets associated with the parameter combination of {2, 2, 4};
if the second number is two and the bitmap of the CSI-RS resource is one of [1, 1, 0, 0], [1, 0, 1, 0] and [0, 1, 1, 0], the first parameter aggregation is {2, 2}, and the second parameter set is determined from a plurality of parameter sets associated with the parameter combination of {2, 2};
if the second number is two and the bitmap of the CSI-RS resource is one of [1, 0, 0, 1], [0, 1, 0, 1] and [0, 0, 1, 1], the first parameter aggregation is {2, 4}, and the second parameter set is determined from a plurality of parameter sets associated with the parameter combination of {2, 4};
if the second number is one and the bitmap of the CSI-RS resource is one of [1, 0, 0, 1], [0, 1, 0, 0] and [0, 0, 1, 0], the first parameter aggregation is {2}, and the second parameter set is determined from a plurality of parameter sets associated with the parameter combination of {2}; or
if the second number is one and the bitmap of the CSI-RS resource is [0, 0, 0, 1] the first parameter aggregation is {4}, and the second parameter set is determined from a plurality of parameter sets associated with the parameter combination of {4}.

14. The terminal device of claim 1, wherein if the first combination is {2, 2, 4, 4}, and wherein,
if the second number is four, the first parameter aggregation is the same with the first parameter combination, and the second parameter set is the same with the first parameter set;
if the second number is three and the bitmap of the CSI-RS resource is [1, 1, 1, 0] or [1, 1, 0, 1], the first parameter aggregation is {2, 2, 4}, and the second parameter set is determined from a plurality of parameter sets associated with the parameter combination of {2, 2, 4};
if the second number is three and the bitmap of the CSI-RS resource is [1, 0, 1, 1] or [0, 1, 1, 1], the first parameter aggregation is a replaced parameter combination, the second parameter set is determined from a plurality of parameter sets associated with the replaced parameter combination, and the replaced parameter combination is one of {2, 2, 4, 4}, {2, 2, 2, 4}, {4, 4, 4} and {2, 2, 4};
if the second number is two and the bitmap of the CSI-RS resource is [1, 1, 0, 0], the first parameter aggregation is {2, 2}, and the second parameter set is determined from a plurality of parameter sets associated with the parameter combination of {2, 2};
if the second number is two and the bitmap of the CSI-RS resource is one of [1, 0, 1, 0], [0, 1, 1, 0], [1, 0, 0, 1] and [0, 1, 0, 1], the first parameter aggregation is {2, 4}, and the second parameter set is determined from a plurality of parameter sets associated with the parameter combination of {2, 4};
if the second number is two and the bitmap of the CSI-RS resource is [0, 0, 1, 1], the first parameter aggregation is {4, 4}, and the second parameter set is determined from a plurality of parameter sets associated with the parameter combination of {4, 4};
if the second number is one and the bitmap of the CSI-RS resource is [1, 0, 0, 0] or [0, 1, 0, 0], the first parameter aggregation is {2}, and the second parameter set is determined from a plurality of parameter sets associated with the parameter combination of {2}; or
if the second number is one and the bitmap of the CSI-RS resource is [0, 0, 1, 0] or [0, 0, 0, 1], the first parameter aggregation is {4}, and the second parameter set is determined from a plurality of parameter sets associated with the parameter combination of {4}.

15. The terminal device of claim 1, wherein the processor is further configured to cause the terminal device to:
receive, from the network device, at least one codebook configuration indicating a plurality of parameters to be used by the terminal device, the plurality of parameters comprising at least one of the following:
a first parameter indicating a maximum number of CSI-RS resources,
a second parameter indicating a number of the at least one parameter combination,
a third parameter indicating the at least one parameter combination,
a fourth parameter indicating a plurality of supported parameter sets, or
a fifth parameter indicating whether selection of at least one CSI-RS resource is enabled.

16. The terminal device of claim 15, wherein,
the first, second, third, fourth and fifth parameters are indicated separately;
the second and the third parameters are indicated jointly, while the first, fourth and fifth parameters are indicated separately;
the first, second and the third parameters are indicated jointly, while the fourth and fifth parameters are indicated separately;
the first, second, third and the fourth parameters are indicated jointly, while the fifth parameter is indicated separately; or
the second, third and the fourth parameters are indicated jointly, while the first and fifth parameters are indicated separately.

17. The terminal device of claim 15, wherein all of the at least one parameter combination corresponds to the first number of CSI-RS resources, or the at least one parameter combination comprises a further parameter combination corresponding to a third number of CSI-RS resources different from the first number of CSI-RS resources.

18. The terminal device of claim 14, wherein at least one of the CSI-RS resource in the first number of CSI-RS resources is configured with a codebook subset restriction (CBSR) configuration, and the processor is further configured to cause the terminal device to:
determine whether to apply the CBSR configuration based on:
the second number of the CSI-RS resources, and
an indication indicating whether the CBSR configuration is configured to be off.

19. The terminal device of claim 15, wherein determining whether to apply the CBSR configuration comprises:
if the second number is larger than one, the CBSR configuration is ignored if the CBSR configuration is configured to be off, or
if the second number is equal to one, the CBSR configuration is applied even if the CBSR configuration is configured to be off.

20. A network device comprising:
a processor configured to cause the terminal device to:
transmit, to a terminal device, at least one codebook configuration indicating a plurality of parameters to be used by the terminal device, the plurality of parameters comprising:
a first parameter indicating a maximum number of channel state information reference signal (CSI-RS) resources,
a second parameter indicating a number of at least one parameter combination for codebook,
a third parameter indicating the at least one parameter combination for codebook,
a fourth parameter indicating a plurality of supported parameter sets for codebook, and
a fifth parameter indicating whether selection of at least one CSI-RS resource is enabled,
receive, from the terminal device, a report indicating at least one codebook indicator generated based on the codebook configuration.
